(19) United States
(12) Patent Application Publication
(10) Pub. No.: US 2011/0224913 A1
(43) Pub. Date: Sep. 15, 2011

(54) METHODS AND SYSTEMS FOR PREDICTING PROTEINS THAT CAN BE SECRETED INTO BODILY FLUIDS

(76) Inventors: Juan Cui, Athens, GA (US); David Puett, Athens, GA (US); Ying Xu, Bogart, GA (US)

(21) Appl. No.: 13/055,251

(22) PCT Filed: Aug. 10, 2009
(86) PCT No.: PCT/US2009/053309

§ 371 Date: Apr. 14, 2011

Related U.S. Application Data
(60) Provisional application No. 61/136,043, filed on Aug. 8, 2008.

(51) Int. Cl. G06F 19/00

(52) U.S. Cl. 702/19

(57) ABSTRACT

The present invention is directed to methods and systems for predicting protein secretion into bodily fluids. In an embodiment, a method uses a feature set comprising secretory properties of collected proteins to train a classifier, based on the feature set, to recognize protein features corresponding to proteins that are likely to be secreted into a biological fluid. Another method determines, using a trained classifier and identified features of a received protein sequence, the probability of the protein sequence being secreted into a biological fluid. In an embodiment, a system predicts the secretion of proteins into a biological fluid. The system comprises components configured to construct a protein feature set comprising properties of collected proteins, train a classifier to predict features of a protein that is likely to be secreted into the biological fluid, receive a protein sequence, and identify the received protein sequence as a secretory protein.

### STATEMENT REGARDING FEDERALLY-SPONSORED RESEARCH AND DEVELOPMENT

Part of the work performed during development of this invention utilized U.S. Government funds under NSF/ITR-IIS-0407204 awarded by National Science Foundation. Therefore, the U.S. Government has certain rights in this invention.

### FIELD OF THE INVENTION

The present invention is generally directed to computational analysis of human proteins, and more particularly directed to predicting protein secretion into bodily fluids, such as blood.

### BACKGROUND

Alterations in gene and protein expression provide important clues about the physiological states of a tissue or an organ. During malignant transformation, genetic alterations in tumor cells can disrupt autocrine and paracrine signaling networks, leading to the over-expression of some classes of proteins such as growth factors, cytokines and hormones that may be secreted outside of the cancerous cells (Hanahan and Weinberg, 2000; Sporn and Roberts, 1985). These and other secreted proteins may get into saliva, blood, urine, cerebrospinal (spinal) fluid, seminal fluid, vaginal fluid, ocular fluid, or other bodily fluids through complex secretion pathways.

Genomic studies on various cancer specimens have identified numerous genes that are consistently over-expressed and some of these genes encode secreted proteins (Buckhaults et al., 2001; Welsh et al., 2003; Welsh et al., 2001). For example, the prostasin and osteopontin genes have elevated expression levels in ovarian cancer while the MIC1 gene is over-expressed in colorectal, breast, and prostate cancers. The increased abundance of these secretory proteins has been detected in the serum of patients harboring these cancers compared to the healthy individuals (Kim et al., 2002; Mok et al., 2001; Welsh et al., 2003). It has also been found that some of the secreted proteins have shown varying levels of concentration increases in serum associated with different developmental stages of cancers, suggesting that they could possibly be used as markers of both cancer typing and staging (Huang et al., 2006).

There are difficulties and challenges associated with accurately predicting which proteins are likely to be secreted into bodily fluids. One of the difficulties is that large numbers of protein sequences and biological fluid samples must be analyzed and classified.

Classifying data is a common task performed in order to decide or predict the class for a data item. Traditional, linear classifiers examine groups of collected data items, wherein each of the data items belong to one of two classes, and the classifier is ‘trained’ using properties of the collected data items, to decide which class a new data item will be in. One traditional classifier is a support vector machine (SVM). With a SVM, a data item is viewed as a p-dimensional vector (a list of p numbers), and the SVM is used to determine whether such data items can be separated with a p-1-dimensional hyperplane. Use of SVMs is a currently available technique for data classification and regression analysis. While some studies have looked at proteins that may be secreted outside of cells, there are no currently available methods for predicting proteins that can be secreted into a specific bodily fluid, such as blood or urine. Using the prediction programs designed for extracellularly secretory proteins as an approximation tool for prediction of proteins that can get into bodily fluids does not give reliable predictions. Accordingly, what is needed are methods and systems that allow training of classifiers to distinguish proteins that can get into bodily fluids from proteins that cannot, using some protein features. Additionally, methods and systems are required to carry out feature selection in order to optimize the performance of the classifiers such that secretion of proteins into bodily fluids can be accurately predicted.

In order to diagnose cancers and other diseases, accurate predictions must be made regarding which proteins from highly and abnormally expressed genes in diseased tissues, such as cancers, can be secreted into bodily fluids. A difficulty associated with solving this problem is that current understanding of downstream localization after proteins are secreted outside of cells is very limited and the current knowledge is not sufficient to provide useful hints about secretion of proteins to bodily fluids. Accordingly, what is needed is a data classification method for predicting which human proteins would likely be secreted into bodily fluids.

The human serum proteome is a very complex mixture of highly abundant proteins, such as albumin, immunoglobulins, transferrin, haptoglobin and lipoproteins, as well as proteins and peptides that are secreted from different tissues, diseased or normal, or leak from cells throughout the human body (Adkins et al., 2002; Schrader and Schulz-Knappe, 2001). A challenging issue when working with the human serum proteome is that most of the circulating native blood proteins are orders of magnitude more abundant than those of the putative proteins of interest. Hence, it is very difficult to experimentally detect such secreted proteins, and their increased relative abundance in blood, among thousands or possibly more native blood proteins without knowing what proteins or protein features to look for in blood a priori. Accordingly, what is needed are methods and systems that employ novel computational approaches to predict proteins that are both abnormally highly expressed in cancer tissues and can be secreted into bodily fluids, thus providing a target list for targeted proteomic work of bodily fluids, such as human blood serum, and enabling the identification of marker proteins in bodily fluids more realistically solvable.

Numerous studies have been carried out to predict proteins that can be secreted to the cell surface or into the extracellular environments in both eukaryotes and prokaryotes, and several public prediction servers are available (Guda, 2006; Horton et al., 2007; Menne et al., 2000; Nair and Rost, 2005). Most of these methods have been developed based on general understanding of protein subcellular localization—localization of most proteins is done through a cascade of sorting events that are directed by short (signal) peptides or motifs that enable site-specific uptake, retention, and transport (Doudna and Batey, 2004; Tjalsma et al., 2000). These programs have been developed using various statistical learning methods, based on information such as amino acid composition, co-occurrence of protein domains and annotated protein functions (Guda, 2006; Mott et al., 2002).

Although previous studies are concerned about whether a protein is secreted outside of a cell, these studies are not concerned with predicting where the proteins will ultimately end up. While previous studies may have determined if expressions of proteins secreted into bodily fluids are correlated with various pathological conditions, they do not include methods for determining what the secreted proteins have in common in terms of their physical and chemical properties, amino acid sequence, and structural features. Traditional methods do not calculate a probability, based upon protein features, of proteins being secreted into a bodily fluid. Yet, from previous proteomic studies, these calculated probabilities will be useful in aiding in diagnosis of pathological conditions. Accordingly, methods and systems are needed to calculate the probability of the presence of proteins in a bodily fluid in order to aid in diagnosis of pathological conditions.

### SUMMARY

Methods, systems, and computer program products for predicting proteins to be secreted into bodily fluids are disclosed. Reliable predictions of protein secretion into bodily fluids provided by embodiments of the present invention will enable more timely and accurate diagnosis of pathological conditions such as cancer. In embodiments of the invention, the bodily fluids include, but are not limited to, saliva, blood, urine, spinal fluid, seminal fluid, vaginal fluid, amniotic fluid, gingival crevicular fluid, and ocular fluid. In one embodiment, a method predicts which proteins from highly and abnormally expressed genes in diseased human tissues, such as cancer, can be secreted into a bodily fluid, suggesting possible marker proteins for follow-up proteomic studies. In another embodiment, a Blood Secreted Protein Prediction (BSPP) server performs a computer-implemented method for predicting which proteins from abnormally expressed genes in diseased human tissues, such as cancer, can be secreted into the bloodstream, suggesting possible marker proteins for follow-up serum proteomic studies.

In an embodiment of the present invention, a list of protein features in one or more protein sequences are identified including, but not limited to, signal peptides, transmembrane domains, glycosylation sites, disordered regions, secondary structural content, hydrophobicity and polarity measures that show relevance to protein secretion. A Support Vector Machine (SVM)-based classifier can be trained using these features to predict protein secretion to the bloodstream.

To illustrate the present invention, the invention was first applied to predicting whether proteins would be secreted into blood and then it was separately applied to predicting secretions into urine. However, it is understood that the present invention has broader application to developing tools and systems for predicting whether proteins are secreted into other bodily fluids such as, but not limited to, saliva, spinal fluid, seminal fluid, vaginal fluid, and ocular fluid.

### BRIEF DESCRIPTION OF THE DRAWINGS/FIGURES

FIG. 1 shows a flowchart illustrating an exemplary process for training a classifier and predicting protein secretion into a bodily fluid, in accordance with an embodiment of the present invention.

FIG. 2 shows a statistical relationship between the R-value (reliability score) and P-value (probability of correct classification) derived from the analysis of 305 positive and 26,962 negative samples of proteins, in accordance with an embodiment of the invention.

FIG. 3 illustrates an exemplary graphical user interface (GUI), wherein pluralities of protein sequences can be provided in order to predict which proteins can be secreted into the bloodstream, in accordance with an embodiment of the invention.

FIG. 4 depicts a received protein sequence to be classified within an exemplary GUI, in accordance with an embodiment of the invention.

FIG. 5 depicts a negative classification result for a protein sequence displayed within an exemplary GUI, in accordance with an embodiment of the invention.

FIG. 6 depicts a positive classification result for a protein sequence displayed within an exemplary GUI, in accordance with an embodiment of the invention.

FIG. 7 depicts an example computer system useful for implementing components of a system for predicting whether proteins can be secreted into bodily fluids, according to an embodiment of the invention.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF THE INVENTION

The present invention is directed to methods, systems, and computer program products for predicting whether proteins are secreted into a biological fluid such as, but not limited to, saliva, blood, urine, spinal fluid, seminal fluid, vaginal fluid, and ocular fluid. The present invention includes system, method, and computer program product embodiments for receiving one or more protein sequences and analyzing the features of the received protein sequences to determine a probability that the protein can be secreted into a bodily fluid. An embodiment of the invention includes a graphical user interface (GUI) which allows a user to provide a plurality of protein sequences and analyze the plurality of sequences to predict whether proteins represented by the sequences will be secreted into the bloodstream.

Although the present specification describes user-provided protein sequences and user-inputted protein sequences, users can be people, computer programs, software applications, software agents, macros, etc. Accordingly, unless specifically stated, the term “user” as used herein does not necessarily pertain to a human being.

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment of the invention”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The description of “a” or “an” item herein may refer to a single item or multiple items. For example, the description of a feature, a protein, a bodily fluid, or a classifier may refer to a single feature, a protein, a bodily fluid, or a classifier. Alternatively, the description of a feature, a protein, a bodily fluid, or a classifier may refer to multiple features, proteins, bodily fluids, or classifiers. Thus, as used herein, “a” or “an” may be singular or plural. Similarly, references to and descriptions of plural items may refer to single items.

The specification describes a general approach for predicting secretion of proteins into a bodily fluid. Specific exemplary embodiments for predicting secretion of proteins into the bloodstream and urine are provided herein. However, based on the teaching and guidance presented herein, it is understood that it is within the knowledge of one skilled in the art to readily adapt the methods described herein to predict secretion of proteins into other bodily fluids, such as, but not limited to, saliva, spinal fluid, seminal fluid, vaginal fluid, amniotic fluid, gingival crevicular fluid, and ocular fluid.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

### Method for Training a Classifier

Data classification methods represent a general class of computational methods that attempt to determine which pre-defined classes each data element in a given data set belongs to, based on the provided feature values of each data element.

Various supervised learning methods, such as a Support Vector Machine (SVM), artificial neural network (ANN), decision tree, regression models, and other algorithms have been widely implemented for data classification and regression models. Based on known data (knowledge in the form of a training data set), those supervised learning methods enable a computer to automatically learn to recognize complex patterns and develop a classifier, which can in turn be used for making intelligent decisions and predicting the class of unknown data (an independent set).

Machine learning-based classifiers have been applied in various fields such as machine perception, medical diagnosis, bioinformatics, brain-machine interfaces, classifying DNA sequences, and object recognition in computer vision. Learning-based classifiers have proven to be highly efficient in solving some biological problems. As used herein, classification is the process of learning to separate data points into different classes by finding common features between collected data points which are within known classes. Classification can be done using neural networks, regression analysis, or other techniques. A classifier is a method, algorithm, computer program, or system for performing data classification. One type of classifier is a Support Vector Machine (SVM). Traditional SVMs are based on the concept of decision hyperplanes that define decision boundaries. A decision hyperplane is one that separates between a set of objects having different class memberships. For example, collected objects may belong either to class one or class two and a classifier, such as an SVM can be used to determine (i.e., predict) the class (e.g., one or two) of any new object to be classified. Traditional SVMs are primarily classifier methods that perform classification tasks by constructing hyperplanes in a multidimensional space that separates cases of different class labels. SVMs can support both regression and classification tasks and can handle multiple continuous and categorical variables. In embodiments of the present invention, an SVM-based classifier is trained to predict the class of protein sequences as either being secreted or not secreted into a bodily fluid.

In the following section, an exemplary embodiment of an implementation of the present invention is presented with reference to steps of a method. The implementation discussed below relates to predicting secretions of proteins into blood. What follows is a description of how specific implementations of the invention were applied to different sets of collected proteins.

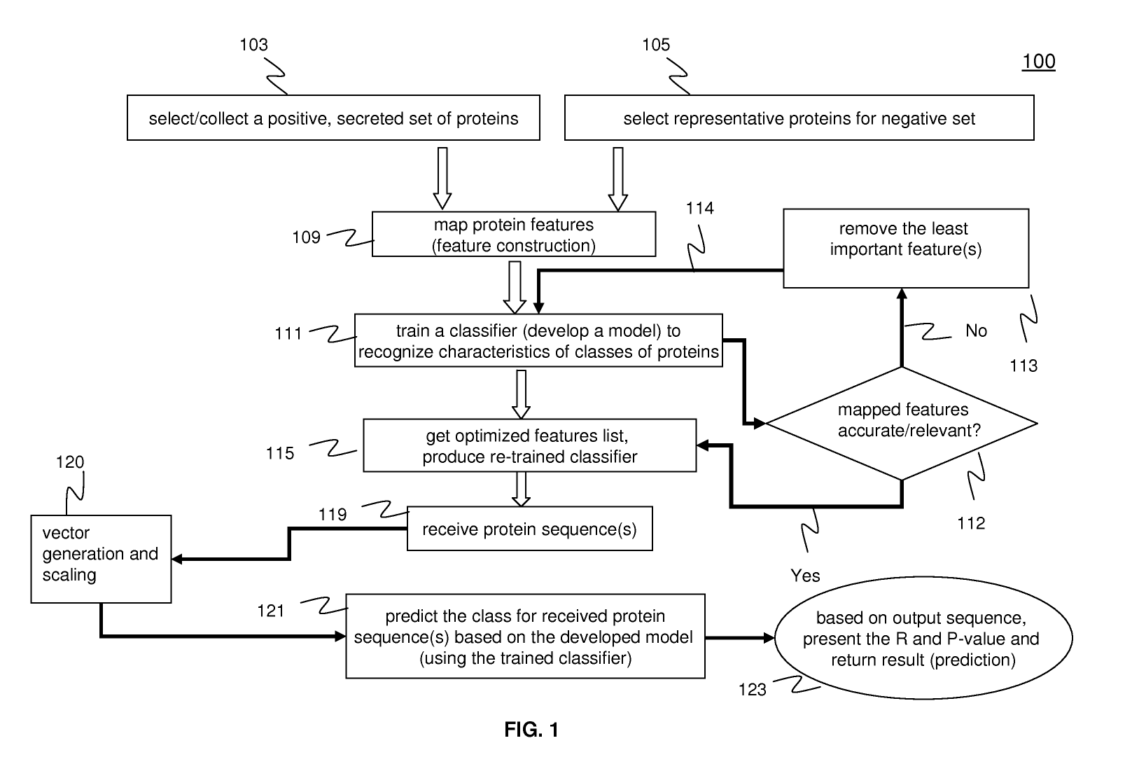

In one embodiment, human proteins that are annotated as secretory proteins are collected from known protein databases, such as the Swiss-Prot and Secreted Protein Database (SPD) databases, and proteins that have been detected experimentally in blood by previous studies are selected. Chen et al. (2005) describes a web-based SPD. FIG. 1 shows a flowchart illustrating an exemplary method 100 for training a classifier. Some properties, or protein features, are important to characterize a group of collected proteins, but may not be efficient if used individually as a filter. Method 100 considers these properties together and evaluates the importance computationally instead of empirically.

In the example shown, method 100 illustrates the steps by which a classifier can be trained. Note that the steps in method 100 do not necessarily have to occur in the order shown.

In step 103, the process begins with the selection of a set of proteins as ‘positive’ data set. In an embodiment, step 103 comprises collecting proteins known to be secreted into the bloodstream, i.e., blood-secreted proteins. In other embodiments of the invention, this step comprises collecting proteins known to be secreted into other bodily fluids such as, but not limited to, saliva, urine, spinal fluid, seminal fluid, vaginal fluid, amniotic fluid, gingival crevicular fluid, and ocular fluid. It is understood that the positive and negative data sets selected in steps 103 and 105, respectively, should be sufficiently large to yield a statistically consistent and reliable results when training the classifier in steps 111-115 (discussed below). In general, larger positive and negative sets of proteins are preferable.

In one implementation, in step 103, a total of 1,620 human proteins that are annotated as secretory proteins are collected from the Swiss-Prot protein database and the Secreted Protein Database (SPD) (Chen et al., 2005), and proteins that have been detected experimentally in blood by previous studies are selected. This is done by checking the 1,620 proteins against the known serum protein data set compiled by the Plasma Proteome Project (PPP) (Omenn et al., 2005) and a few additional data sets generated by other serum proteomic studies (Adkins et al., 2002; Pieper et al., 2003), which consist of a total of ˜16,000 proteins. 305 of the 1,620 proteins match at least two peptides with the ˜16,000 proteins, and hence these 305 proteins are considered to be secreted into blood—a common practice for protein identification based on mass spectrometry data. To ensure the quality of the positive data set selected in step 103, in a embodiment, these 305 proteins which meet two criteria (both secreted and serum/plasma detected) are chosen, as the positive dataset and did not include proteins that leak into the blood as a result of cell damage (e.g. cardiac myoglobin released into plasma after a heart attack).

In step 105, representative proteins from other classes and protein families, not selected in step 103 are selected as a ‘negative’ data set. In an embodiment, this step includes collecting non-blood secreted proteins. In alternative embodiments, step 105 comprises collecting proteins known to not be secreted into other bodily fluids such as, but not limited to saliva, urine, spinal fluid, seminal fluid, vaginal fluid, amniotic fluid, gingival crevicular fluid, and ocular fluid.

In an embodiment of the invention, a negative dataset of proteins is generated in step 105 by selecting representatives from non-blood-secreted proteins, which should include both proteins unrelated to secretory pathway and secreted proteins not involved in the circulatory system. In one embodiment, this step comprises selecting three representatives from each of the protein family (Pfam) databases (Bateman et al., 2002) that contain no previously mentioned blood-secreted proteins as the negative set.

In some embodiments, in order to obtain a non-redundant data set for a final independent evaluation step (step 121 described below), a Basic Local Alignment Search Tool (BLAST) (Altschul et al., 1997) is used to remove the redundant proteins using 10%, 20%, or 30% sequence identity as the cutoff. In the above embodiment, using 20% sequence identity as the cutoff, gave rise to 56 positive and 13,716 negative proteins. The remaining, 249 positive and 13,246 negative proteins, are divided into separate training and testing sets, respectively, using the following procedure. According to an embodiment, the proteins in the positive set selected in step 103 are divided into clusters based on the similarity of the selected features, which will be described in further detail with reference to step 109 (feature selection) below, measured by the Euclidean distance, using a hierarchical clustering method (Jardine and Sibson, 1968). In one embodiment, 151 clusters are obtained with the ratio between the maximum intra-cluster distance and the minimum inter-cluster distance for each cluster, ranging from 0.27 to 0.51. From each cluster, one representative protein is chosen randomly to form the positive training set in step 103. The negative training set is chosen similarly in step 105. The training set is selected in this way to ensure it is sufficiently diverse and broadly distributed in the feature space. The remaining proteins are used as the test set. This process is repeated to construct 5 different data sets to train the classifier in step 111, described below, which can be used to assess the stability of the data generation strategy.

Steps 103 and 105 may be performed in parallel or sequentially. After the positive and negative data sets are selected in steps 103 and 105, respectively, the method proceeds to step 109.

### Feature Construction

In step 109, the features associated with proteins in both the positive and negative data sets are mapped. In an embodiment, step 109 includes analyzing proteins in the positive and negative data sets to map protein features such as, but not limited to the features listed in Table 1 below. In Table 1, the numbers in parentheses represent the vector dimension of each property. For example, properties or features having multiple dimensions can be represented by a multi-dimension vector. By way of example, polarity of a protein can be represented as a continuum or range in a 21-dimension vector, denoted as “polarity (21)” in Table 1. It is understood that protein features can differ for different fluids. Accordingly, the features listed in Table 1 can differ for different biological fluids. Features such as protein size, amino acid composition, di-peptide composition, secondary structure, domain, motif, solubility, hydrophobicity, normalized Van der Waals volume, polarity, polarizability, charge, surface tension, and solvent accessibility are mapped for the positive and negative protein classes selected in steps 103 and 105. The protein features listed in Table 1 can be roughly grouped into four categories: (i) general sequence features such as amino acid composition, sequence length, and di-peptide composition (Bhasin and Raghava, 2004; Reczko and Bohr, 1994); (ii) physicochemical properties such as solubility, disordered regions, hydrophobicity, normalized Van der Waals volume, polarity, polarizability, and charges, (iii) structural properties such as secondary structural content, solvent accessibility, and radius of gyration, and (iv) domains/motifs such as signal peptides, transmembrane domains, and twin-arginine signal peptides motif (TAT). In total, 25 properties are included in the initial list, which give rise to a 1,521-dimensional feature vector for each protein sequence. Note that for each included property, a different amount of information is needed to encode it in a feature vector representation of the properties. For example, amino acid composition and di-peptide composition are represented as a 20- and a 400-dimensional feature vector, respectively. The feature vector of the secondary structural content is a 4-dimensional vector, including alpha-helix content, beta-strand content, coil content, and the assigned class by the Secondary Structural Content Prediction (SSCP) program (Eisenhaber et al., 1996). An encoding of physicochemical properties is illustrated by the example of hydrophobicity feature vector: amino acids can be divided into hydrophobic (C,V,L,I,M,F,W), neutral (G,A,S,T,P,H,Y), and polar (R,K,E,D,Q,N) groups. Three descriptors, composition (C), transition (T), and distribution (D), are used to describe the global composition with C being the number of amino acids of a particular group (such as hydrophobic) divided by the total number of amino acids in the protein sequence (Cai et al., 2003; Cui et al., 2007; Dubchak et al., 1995); T being the relative frequency in changing amino acid groups along the protein sequence, and D denoting the chain length within which the first, 25%, 50%, 75%, and 100% of the amino acids of a particular group is located, respectively. Overall, 21 elements are used to represent these three descriptors: 3 for C, 3 for T, and 15 for D. By following these procedures, the feature vector of a protein is constructed using a total of 1,521 feature elements.

TABLE 1
A list of initial features for prediction of blood-secreted proteins

| Type of properties | Features (dimension) | Sources |
|---|---|---|
| General sequence | Amino acid composition (20), sequence | Locally calculated. |
| features | length (1), di-peptides composition (400) | |
| | Normalized Moreau-Broto autocorrelation | Calculated using the Protein Feature Server (PROFEAT) |
| | (240), Moran autocorrelation (240), Geary | developed by the National University of Singapore's |
| | autocorrelation (240), Sequence order (160), | Bioinformatics & Drug Design group (BIDD) within the |
| | Pseudo amino acid composition (50) | Computational Science Department, Science Faculty. |
| Physicochemical | Hydrophobicity (21), normalized Van der | Locally computed with three descriptors: composition |
| properties | Waals volume (21), polarity (21), | (C), transition (T), and distribution (D). |
| | polarizability (21), charge (21), secondary | |
| | structure (21) and solvent accessibility (21) | |
| | Solubility (1), unfoldability (1), disorder | Determined with the sequence-based PROtein SOlubility |
| | regions (3), global charge (1) and | evaluator (PROSO) (Smialowski et al., 2007) and the |
| | hydrophobility (1) | combined transmembrane topology and signal peptide |
| | | predictor (Phobius) from the Stockholm Bioinformatics |
| | | Centre. |
| Structural | Secondary structural content (4), | Determined using the Secondary Structural Content |
| properties | shape (Radius Gyration) (1) | Prediction (SSCP) tool from the European Molecular |
| | | Biology Laboratory and Radius of Gyration filters for |
| | | globular protein Evaluation from the Supercomputing |
| | | Facility for Bioinformatics & Computational Biology, |
| | | Indian Institute of Technology (IIT), Delhi. |
| Domains and motifs | Signal peptide (1), transmembrane domains | Determined using the SignalP tool from the Center for |
| | (alpha helix and beta barrel) (5), | Biological Sequence Analysis at the Technical |
| | Glycosylation (both N-linked and O-linked) | University of Denmark and the amino acid composition |
| | (4), Twin-arginine signal peptides motif | based TransMembrane Barrel-Hunt (TMB-Hunt) tool |
| | (TAT) (1) | (Garrow et al, 2005). |
| | | Calculated using the NetOglyc, NetNgly, and Twin- |
| | | arginine signal peptide (TatP) servers from the Center |
| | | for Biological Sequence Analysis at the Technical |
| | | University of Denmark |

In one embodiment, step 109 comprises examining a number of features computed based on protein sequences and secondary structures that are possibly relevant to the classification of proteins being secreted into a bodily fluid or not. Some features are included because they are known to be relevant to protein secretion while others are included because of their statistical relevance to the classification problem. For example, signal peptides and transmembrane domains are known to be important factors to prediction of extracellularly secreted proteins. The transmembrane portion serves to anchor a protein to the plasma membrane, and it can be cleaved at the cell surface rendering the extracellular component as soluble. Twin-arginine (TAT) signal peptides, only observed in prokaryotes so far, are known to be used to export proteins into the periplasmic compartment or extracellular environment independent of the well-studied Sec-dependent translocation pathway (Bendtsen et al., 2005; Taylor et al., 2006). This motif information is included in the study to check if it may be relevant to transporting folded proteins across the human cell membrane. In addition, it is known that the structures of the capillaries determine that only proteins under a certain size can diffuse through their walls and get into the bloodstream. For example, blood proteins, with the exception of short-lived peptide hormones, are expected to be larger than 45 kDa, the kidney filtration cutoff, and not smaller than the capillary leak-age size that is up to 400 nm in diameter (under some tumor conditions), for their retention in blood (Anderson and Anderson, 2002; Brown and Giaccia, 1998). Hence, information about the protein size and shape is included in an initial feature list. Another important feature is the glycosylation sites. It has been observed that most blood-secreted proteins are glycosylated (Bosques et al., 2006), including important tumor biomarkers such as prostate-specific antigen (PSA) and the ovarian cancer marker CA125. In an embodiment, in order to aid in diagnosis pathological conditions, such as cancer, a second feature set is constructed in step 109. In accordance with this embodiment, the second feature set comprises properties of proteins known to be secreted into the biological fluid due to one or more pathological conditions, such as tumors known to be associated with types of cancers.

According to one embodiment of the invention, in step 109 a number of general features are included in the initial feature list, derived from protein sequence, secondary structural, and physicochemical properties widely used in various protein classification studies such as protein function prediction and protein-protein interaction prediction, as reviewed in (Cui, 2007), which might be relevant to a prediction of blood-secreted proteins. Table 1 summarizes the features discussed above. The actual relevance of these features to the classification problem is assessed using a feature-selection algorithm presented in the following section with reference to step 111.

After the protein features are mapped in step 109, the method proceeds to step 111.

### Classification and Feature Selection

In step 111, a classifier is trained to recognize the respective characteristics of the positive and negative classes of proteins selected in steps 103 and 105. In step 111, the feature mapping created in step 109 is used to train a classifier. In an embodiment, this step comprises training a modified Support Vector Machine (SVM) classifier to distinguish the positive from the negative training data, using a Gaussian kernel (Platt, 1999; Keerthi, 2001). Traditional SVMs have been applied to a wide range of pattern recognition problems in data mining and bioinformatics, such as protein function prediction (Cui, 2007), protein-protein interaction prediction (Ben-Hur and Noble, 2005), and protein subcellular location prediction (Su et al., 2007).

In accordance with an embodiment of the present invention, a specialized, modified SVM-based classifier is used to efficiently calculate the probability of protein secretion into a biological fluid. The Gaussian radial basis function kernel provides superior performance to other, more traditional kernels used in SVM such as linear and polynomial kernels (Ben-Hur and Noble, 2005; Burbidge et al., 2001; Su et al., 2007). Thus, in an embodiment, Gaussian kernel SVM is used for the training the classifier in step 111. In accordance with an embodiment of the invention, the inputs to the modified SVM may include the aforementioned 1,521 features for each protein in the training set, and the output of the classifier is an assignment of the input protein to be blood-secreted or not. An independent evaluation set is used to estimate the accuracy of the overall protein assignment for the whole data set. The classification performance is measured using the prediction sensitivity SE=TP/(TP+FN), prediction specificity SP=TN/(TN+FP), the overall prediction accuracy Q=(TP+TN)/N, Precision=TP/(TP+FP), area under curve (AUC) (Graham, 2002) and Matthews correlation coefficient (MCC) MCC=(TP×TN−FP×FN)/\sqrt{(TP+FN)(TP+FP)(TN+FP)(TN+FN)}. Here TP, TN, FP, and FN are the number of true positive, true negative, false positive, and false negative, respectively, and N=TP+FN+TN+FP is the total number of proteins in the training set. A reliability score, R-value, is used to assess the reliability for each of the predictions, shown as follows:

$$R \text{-} value = \{ \begin{matrix}1 & if d < 0.2 \\ d / 0.2 + 1 & if 0.2 \leq d < 1.8 \\ 10 & if d \geq 1.8\end{matrix}$$

where d is the distance between the position of a target protein in the feature space and the optimal separating hyperplane derived through the SVM training. There is a strong correlation between the R-value and the classification accuracy (probability of correct classification) (Hua and Sun, 2001).

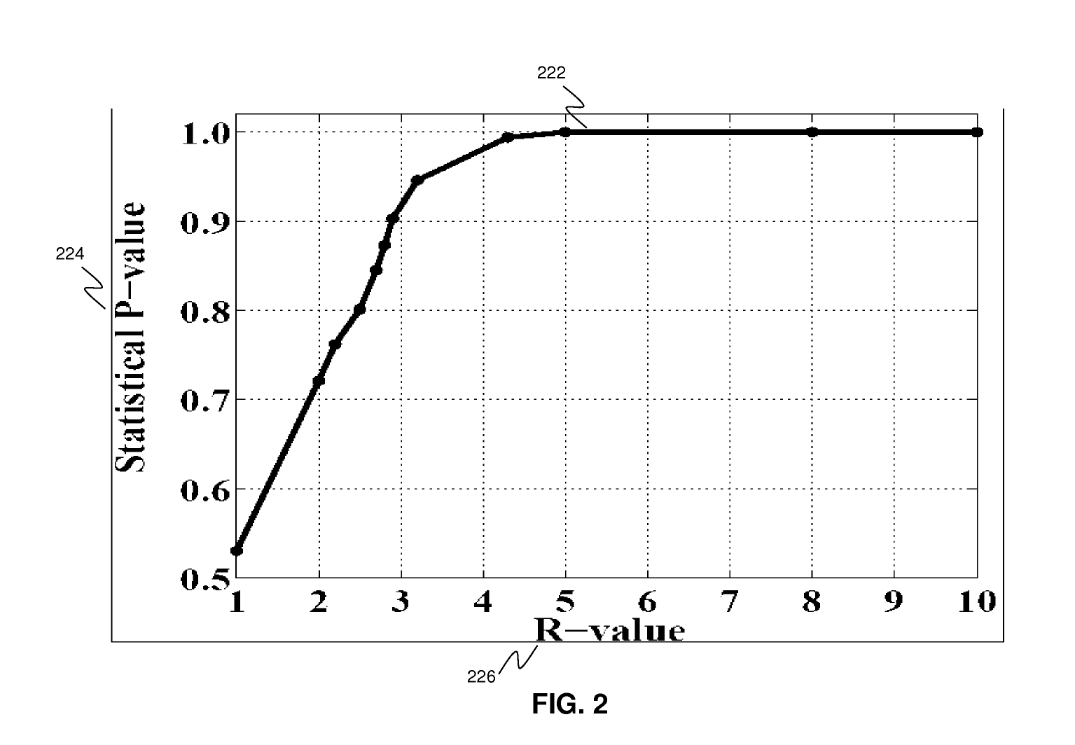

FIG. 2 illustrates the statistical relationship between the R-value (reliability score) and P-value (probability of correct classification) derived from the analysis of 305 positive and 26,962 negative samples of proteins, in accordance with an embodiment of the invention. As illustrated in FIG. 2, a P-value 224 is introduced to indicate the expected classification accuracy, derived from the statistical relationship 222 between the R-value 226 and the actual classification accuracy based on the analysis of 305 positive and 26,962 negative proteins. P-values 224 depicted in FIG. 2 are the expected classification accuracy (probability of correct classification) derived from the statistical relationship between the R-values 226 and actual classification accuracy based on the analysis of 305 positive and 26,962 negative samples of proteins. R-values 226 depicted in FIG. 2 are calculated by a scoring function for estimating the accuracy of a classifier such as an SVM.

In one embodiment, in steps 112 and 113, based on the performance of each classifier initially trained in step 111, a feature selection process, named recursive feature elimination (RFE) (Tang et al., 2007), is used to remove features irrelevant or negligible to the classification goal.

In step 112, a determination is made whether the mapped features, i.e., the features constructed in step 109 are accurate and relevant. The accuracy and relevancy of features is described below. If yes, then method 100 proceeds to step 115. If no, then method 100 proceeds to step 113 where the least relevant features are removed.

In one embodiment, the importance or relevance of the protein features is determined in step 112 by examining the accuracy of classifications correlated with the features. For example, Moreau-Broto autocorrelation descriptors defined as:

$$A C ( d ) = {\sum }_{i = 1}^{N - d} {P}_{i} {P}_{i + d}$$

have been reported to be useful to prediction of membrane proteins based on the hydrophobic index of amino acids. Feng and Zhang (2000) describe one mechanism for predicting membrane protein types based on the hydrophobic index of amino acids. However, one embodiment of the invention shows that some features do not contribute to the accuracy of the classification. For example, using the Moreau-Broto autocorrelation descriptor defined above, where d is the lag of the autocorrelation, and Pᵢ and P_{i+d} are the hydrophobicity of the amino acids at position i and i+d, respectively, the hydrophobicity of amino acids was not found to be an accurate feature. Hence, it is removed from the initial feature list in step 113, by the RFE procedure.

Protein features important for characterizing blood-secreted proteins as selected by the RFE procedure are listed in Table 2 below. In Table 2, the numbers following the protein feature descriptions indicate the last dimension of a corresponding vector representing a feature. For example, “Distribution of Charge 15” denotes the 15^{th} dimension of the vector representing the distribution of charge for a protein. Additionally, “Distribution of Charge 15” further indicates that distribution of charge values for proteins are represented by a multi-dimension vector having at least 15 dimensions. It is understood that the protein features and corresponding vectors can differ for different biological fluids. By way of example, distribution of charge may only be represented by a 10-dimension vector in some non-blood biological fluids. Similarly, the rankings listed in Table 2 can differ as a function of selecting different positive and negative protein sets in steps 103 and 105.

In step 113, based upon the relative accuracy and relevancy determined in step 111, the least important features are removed. In accordance with an embodiment of the present invention, steps 112 and 113 iteratively remove irrelevant features based on a consensus scoring scheme and gene-ranking consistency evaluation. Tang et al. (2007) describe one such scheme for doing this. Other schemes, of course, exist and can be implemented. After features are removed in step 113, another iteration 114 of step 111 can be performed, thereby re-training the classifier using the now-reduced feature set. Specifically, in each iteration of steps 112 and 113, features with the lowest score (least ranked) given by RFE based on randomly sampled training data are eliminated from the feature list. Essentially a majority-rule voting scheme is used to overcome possible discrepancies among different randomly chosen samples. This iterative process of repeating steps 112-114 continues until a manageable, reduced set of features, without losing the classification performance, is obtained, thereby producing a trained classifier in step 115. The goal of repeating steps 112-114 is to reduce the initial feature set to a minimal feature set that still enables accurate classification to be performed.

TABLE 2
Features important for characterizing blood-secreted proteins as selected by the
RFE method.

| Rank | Index | Feature Description* | Rank | Index | Feature Description |
|---|---|---|---|---|---|
| 1 | F17 | log P BBTM/Non-BBTM protein ratio | 44 | F46 | Transition of Normalized van der Waals |
| | | | | | (VdW) volumes 1 |
| 2 | F138 | Distribution of Charge 15 | 45 | F68 | Distribution of Hydrophobicity 5 |
| 3 | F14 | TatP motif | 46 | F95 | Distribution of Polarity 2 |
| 4 | F61 | Transition of Solvent accessibility 1 | 47 | F143 | Distribution of Secondary structure 5 |
| 5 | F5 | Transmembrane domain | 48 | F49 | Transition of Polarity 1 |
| 6 | F103 | Distribution of Polarity 10 | 49 | F148 | Distribution of Secondary structure 10 |
| 7 | F97 | Distribution of Polarity 4 | 50 | F2 | beta-contents |
| 8 | F56 | Transition of Charge 2 | 51 | F113 | Distribution of Polarizability 5 |
| 9 | F62 | Transition of Solvent accessibility 2 | 52 | F9 | Charge |
| 10 | F18 | Signal peptide | 53 | F30 | Composition of Polarity 3 |
| 11 | F75 | Distribution of Hydrophobicity 12 | 54 | F118 | Distribution of Polarizability 10 |
| 12 | F21 | Mucin type GalNAc O-glycosylation sites | 55 | F144 | Distribution of Secondary structure 6 |
| | | (NetOgly) motif | | | |
| 13 | F107 | Distribution of Polarity 14 | 56 | F149 | Distribution of Secondary structure 11 |
| 14 | F100 | Distribution of Polarity 7 | 57 | F150 | Distribution of Secondary structure 12 |
| 15 | F123 | Distribution of Polarizability 15 | 58 | F139 | Distribution of Secondary structure 1 |
| 16 | F4 | Type of alpha, beta, gamma | 59 | F99 | Distribution of Polarity 6 |
| 17 | F44 | Transition of Hydrophobicity 2 | 60 | F91 | Distribution of Normalized vdW volumes 13 |
| 18 | F50 | Transition of Polarity 2 | 61 | F7 | Size |
| 19 | F85 | Distribution of Normalized vdW volumes 7 | 62 | F8 | Unfoldability |
| 20 | F137 | Distribution of Charge 14 | 63 | F67 | Distribution of Hydrophobicity 4 |
| 21 | F165 | Distribution of Solvent accessibility 12 | 64 | F83 | Distribution of Normalized vdW volumes 5 |
| 22 | F135 | Distribution of Charge 12 | 65 | F142 | Distribution of Secondary structure 4 |
| 23 | F163 | Distribution of Solvent accessibility 10 | 66 | F157 | Distribution of Solvent accessibility 4 |
| 24 | F71 | Distribution of Hydrophobicity 8 | 67 | F16 | BBTM protein score |
| 25 | F80 | Distribution of Normalized vdW volumes 2 | 68 | F112 | Distribution of Polarizability 4 |
| 26 | F92 | Distribution of Normalized vdW volumes 14 | 69 | F130 | Distribution of Charge 7 |
| 27 | F133 | Distribution of Charge 10 | 70 | F153 | Distribution of Secondary structure 15 |
| 28 | F134 | Distribution of Charge 11 | 71 | F48 | Transition of Normalized vdW volumes 3 |
| 29 | F166 | Distribution of Solvent accessibility 13 | 72 | F52 | Transition of Polarizability 1 |
| 30 | F168 | Distribution of Solvent accessibility 15 | 73 | F63 | Transition of Solvent accessibility 3 |
| 31 | F24 | Composition of Hydrophobicity 3 | 74 | F141 | Distribution of Secondary structure 3 |
| 32 | F57 | Transition of Charge 3 | 75 | F34 | Composition of Charge 1 |
| 33 | F104 | Distribution of Polarity 11 | 76 | F39 | Composition of Secondary structure 3 |
| 34 | F116 | Distribution of Polarizability 8 | 77 | F152 | Distribution of Secondary structure 14 |
| 35 | F76 | Distribution of Hydrophobicity 13 | 78 | F53 | Transition of Polarizability 2 |
| 36 | F79 | Distribution of Normalized vdW volumes 1 | 79 | F82 | Distribution of Normalized vdW volumes 4 |
| 37 | F25 | Composition of Normalized vdW volumes 1 | 80 | F126 | Distribution of Charge 3 |
| 38 | F69 | Distribution of Hydrophobicity 6 | 81 | F132 | Distribution of Charge 9 |
| 39 | F45 | Transition of Hydrophobicity 3 | 82 | F147 | Distribution of Secondary structure 9 |
| 40 | F98 | Distribution of Polarity 5 | 83 | F12 | Longest Disordered Region |
| 41 | F121 | Distribution of Polarizability 13 | 84 | F38 | Composition of Secondary structure 2 |
| 42 | F154 | Distribution of Solvent accessibility 1 | 85 | F105 | Distribution of Polarity 12 |
| 43 | F26 | Composition of Normalized vdW volumes 2 | | | |

*Please refer to the feature construction section for more detailed description. For example, “Distribution of Charge 15” denotes the last dimension of the 15-dimension vector representing the distribution of charge.

### Example Trained Support Vector Machine (SVM) Embodiment

In step 115, in one embodiment, a trained version of a Support Vector Machine (SVM) classifier is produced using an initial list of 1,521 protein features based on the provided positive and negative training sets resulting from steps 103 and 105, respectively. The performance of the best traditional classifier is measured by the overall accuracy as defined above, using an independent evaluation set containing 47 positive and 3,296 negative samples. The prediction performance of a traditional classifier yields only approximately 40% accuracy, a clearly undesirable result. This low accuracy level is mostly due to the fact that traditional classifiers use a number of protein features that are irrelevant to the classification and which complicate classifier training for classifiers such as SVM classifiers. Additionally, over-fitting the data by a large classifier with many parameters may be another cause for inaccuracy. Hence, it is desirable to remove some of the less relevant features by carrying out feature selection to optimize the performance of the classifier. In an embodiment of the present invention, a modified version of an SVM classifier, a trained SVM-based classifier is produced to recognize characteristics of a class of proteins, thereby improving classifier performance.

Using the feature selection method outlined above with reference to steps 109-111, in an embodiment, a total of 85 features is selected, which provides improved cross-validation performance of the modified SVM classifier (Tang et al., 2007). The improved cross-validation performance is shown in Table 3 below. The following features are found to be among the most important protein features for classification. These protein features, include, but are not limited to, trans-membrane domains, charges, TatP motif, solubility, polarity, signal peptides, hydrophobicity, O-linked glycosylation motif, and secondary structural content, which rank among the top 20 features. This observation is consistent with the general understanding of secretory proteins, except that the TatP motif is found to contribute substantially to the prediction result produced in step 121, which ranks among the top three features in the prediction, where TatP is known to be used to export proteins into the periplasmic compartment or extracellular environment in Prokaryotes (Bendtsen et al., 2005; Taylor et al., 2006). This represents a novel finding linking the TatP motifs to protein secretion in Eukaryotes.

In an embodiment, based on the 85 selected protein features, five new SVM-based classifiers trained in step 111, produced a trained classifier in step 115. The performance of these trained SVM-based classifiers is then tested using the reduced feature list on the same independent evaluation set. As depicted in Table 5 below, the level of performance by these five classifiers is generally consistent, ranging from 87.2% to 93.7% for the blood-secreted proteins and from 98.2% to 98.6% for non-blood-secreted proteins. The precision, Matthews correlation coefficient (MCC), and the area under the receiver operating characteristic curve (AUC) values of the prediction performance have average values 44.6%, 0.63, and 0.94, respectively. As shown in Table 3, the AUC value is consistent with the earlier performance measures. Interestingly, the precision and MCC seem to be relatively low. The MCC value can fluctuate substantially on comparable evaluation sets, a general and known problem. For example, this problem has been described in Klee and Sosa (2007) and in Smialowski et al. (2007). The relatively low precision and MCC value are partially due to the skewed sizes between the positive and negative evaluation sets, which causes an underestimation of the system performance. In an embodiment, this can be improved by increasing the size of positive set. The classifier with the best sensitivity is chosen such that as many previously unknown blood-secreted proteins as possible can be included, while keeping the specificity high, as shown in Table 3 below.

TABLE 3
Performance statistics of the classifier on prediction of blood-secreted protein and non-
blood-secreted proteins in the training, testing, and independent evaluation sets.

| | Blood- | | Non-blood- | | | | | | |
|---|---|---|---|---|---|---|---|---|---|
| | secreted | | secreted | | Prediction Accuracy | | | | |
| Dataset | TP | FN | TN | FP | SE (%) | SP (%) | Q (%) | MCC | AUC |
| Training | 151 | 0 | 6,545 | 0 | 100 | 100 | 100 | 1.00 | 1.00 |
| Testing | 46 | 5 | 3,253 | 52 | 90.2 | 98.4 | 98.3 | 0.64 | 0.94 |
| Evaluation | 44 | 3 | 3,237 | 59 | 93.6 | 98.2 | 98.1 | 0.63 | 0.95 |

When applying WolF PSORT (Horton et al., 2007), the most cited traditional method for protein extracellular secretion prediction, to the same evaluation set, 81.0% prediction accuracy is achieved with an MCC value of 0.37. This is not surprising since traditional protein-secretion prediction methods, including WolF PSORT, are not designed for solving the problem as both extracellular secretion and secretion into the bloodstream are considered.

In some embodiments, the trained classifier produced in step 115 is further evaluated through a screening test against all human proteins in the Swiss-Prot database, which can provide a more realistic estimate of the prediction performance when applied to large data sets. In this example embodiment, 20,832 human proteins are collected. Among them, 1,563 are annotated as secreted proteins and an additional ˜750 proteins are considered to be relevant to secretion based on their signal peptides and annotated subcellular locations (Welsh et al., 2003). As shown in Table 4 below, the trained classifier produced in step 115 predicts 4,063 proteins, 19.5% of the 20,832 as blood-secreted proteins, which largely agrees with the total (estimated and reported) numbers of secreted proteins and blood proteins (Welsh et al., 2003). All these results suggest that the initial set of 249 positive and 13,244 negative proteins shows good representation of the relevant proteins across the whole protein space.

TABLE 4
Results of screening all human proteins in Swiss-Prot for blood-
secreted proteins.

| Number of human proteins in Swiss-Prot | | 20,832 |
|---|---|---|
| Number of proteins annotated as secreted | | 1,563 |
| Number of potentially secreted proteins based on | | 2,308 |
| signal peptide and location | | |
| Number of blood | All reported | 15,710 |
| proteins | High confidence | 3,020 |

| | |
|---|---|
| Number of SVM predicted blood-secreted proteins | 4,063 |

In addition to the above tests, a list of 240 differentially expressed proteins in human blood due to various diseases can be compiled by an extensive literature search of published proteomics studies. These studies cover multiple cancers in 14 types of human tissues such as pancreas, ovary, melanoma, lung, prostate, stomach, liver, colon, nasopharynx, kidney, uterine cervix, brain, breast, and bladder. Among the 240 proteins, 122 are not included in the initial collection of the 305 blood-secreted proteins, whose names are listed in Table 6. The main reasons for not including these 122 proteins in the initial collection of blood-secreted proteins are: (1) misannotation of these proteins in Swiss-Prot and (2) failure to detect them by the proteomics studies, from which this initial list of proteins is collected. As indicated in their respective studies, all these 122 proteins can be used as potential biomarkers in blood of a particular cancer to discriminate the normal from the tumor tissues or distinguish different developmental stages of a particular cancer. For example, this approach has been used by several groups: Rui et al. (2003) using the heat shock protein beta-1 for breast cancer, Pardo et al. (2007) using cathepsin D for melanoma, Unwin et al. (2003) using L-lactate dehydrogenase for renal cancer, and Bradford et al. (2006) using prostate-specific antigen (PSA) for prostate cancer. At least 97 out of 122 (79.5%) proteins are predicted correctly while the remaining 25 proteins have prediction results inconsistent with the published literature (the names of these 122 proteins are given in Table 4). The minimum accuracy for predicting secretion of proteins into other biological fluids are at least 75% accurate, preferably exceeding 80%, and range up to the accuracies described herein with respect to blood and urine.

After the classifier is produced in step 115, the method proceeds to step 119.

In step 119, one or more protein sequences are received. In an embodiment, a plurality of user-inputted protein sequences can be received in this step. According to an embodiment of the present invention, protein sequences corresponding to proteins collected from a biological fluid are received in the FASTA format in step 119. A protein sequence in the FASTA format begins with a single-line description, followed by lines of sequence data. The FASTA format is a text-based format for representing either nucleotide sequences or peptide sequences, in which base pairs or amino acids are represented using single-letter codes. The FASTA format allows for sequence names and comments to precede protein sequences. The description line is distinguished from the sequence data by a greater-than (“>”) symbol in the first column. FASTA-format sequences are typically comprised of lines of text shorter than 80 characters in length.

In other embodiments of the invention, protein sequences corresponding to proteins collected from a biological fluid are received in other known formats, including, but not limited to a ‘raw’ text format comprising only alphabetic characters. In accordance with an embodiment of the invention, any white spaces, such as spaces, carriage returns, or TAB characters in received protein sequences in the raw text format are ignored.

In an embodiment, one or more protein sequences in step 119 can be parsed to check for compliance with known protein sequence formats. If a valid protein sequence is received, the method proceeds to 120.

In step 120, vectors for the received protein sequences are generated. Each protein sequence is represented as a vector of real numbers. Hence, if there are categorical attributes, they are converted into numeric data in step 120. In this step, scaling of the protein attributes is also performed. Scaling the attributes before applying the trained classifier in step 121 is done to prevent attributes in greater numeric ranges from dominating those in smaller numeric ranges. Another reason for scaling in step 120 is to avoid numerical difficulties during the calculation of secretion probability in step 121. Because kernel values in a classifier usually depend on the inner products of feature vectors, (i.e., a linear kernel and the polynomial kernel) large attribute values may cause numerical problems. After vector generation and scaling, method 100 continues in step 121.

In step 121, the trained classifier produced in step 115 is used to determine the probability that the protein corresponding to the protein sequence received in step 119 is a secreted protein (i.e., predict the class).

The following section provides a few exemplary embodiments of the predictions performed in step 121. In one implementation of the trained classifier using a large test set containing 98 secretory proteins and 6,601 non-secretory human proteins, the classifier achieves ˜90% prediction sensitivity and ˜98% prediction specificity. Sensitivity is the fraction of the number of true positives over the number of true positives plus false negatives. Specificity is the fraction of the number of true positives over the number of true positives plus false positives. Several additional data sets can be used to further assess the performance of the classifier. In an implementation of the trained classifier using a set of 122 proteins that were found to be of abnormally high abundance in human blood due to various cancers, a computer program based on the classifier predicts 62 as blood-secreted proteins. By applying the program to abnormally highly expressed genes in gastric cancer and lung cancer tissues detected through microarray gene-expression studies, 13 and 31 are predicted as blood secreted, respectively, suggesting that they can serve as potential biomarkers for these two cancers, respectively. Some implementations of the present invention demonstrate that method 100 can provide highly useful information to link genomic and proteomic studies for disease biomarker discovery.

In one implementation of the invention, predictions are performed on 122 or more proteins based in part on a model developed using relevant evidence as reported in the literature. Among the correct predictions with supporting evidence from the literature, the tumor necrosis factor, tenascin, C—C motif chemokine 3, and the insulin-like growth factor-binding protein 7 are detected in step 121 with elevated gene-expression levels in cancer patients' serum and are annotated as secreted proteins in Swiss-Prot and SPD database. A web-based SPD is described in Chen et al. (2005). Some membrane proteins, such as calsyntenin-1, immunoglobulin alpha chain C, and hepatocyte growth factor receptor, are predicted in step 122 as secreted proteins but these predictions can only be considered as having partial supporting evidence in the published literature since there is evidence that these proteins are found outside of cells, through secretion or other means, e.g. proteolytic cleavage of membrane-associated proteins. Some predictions in this step can also be partially supported by the annotated protein functions. For example, the thrombospondin 1 precursor is described as an adhesive glycoprotein that mediates cell-to-cell and cell-to-matrix interactions, thus it is expected to function outside of cells. In one embodiment, proteins annotated as secreted proteins but predicted as non-blood-secreted or as blood-secreted proteins but without any evidence showing relevance to secretion are considered as “not consistent with the literature”, such as profilin-1 and carbonic anhydrase 1.

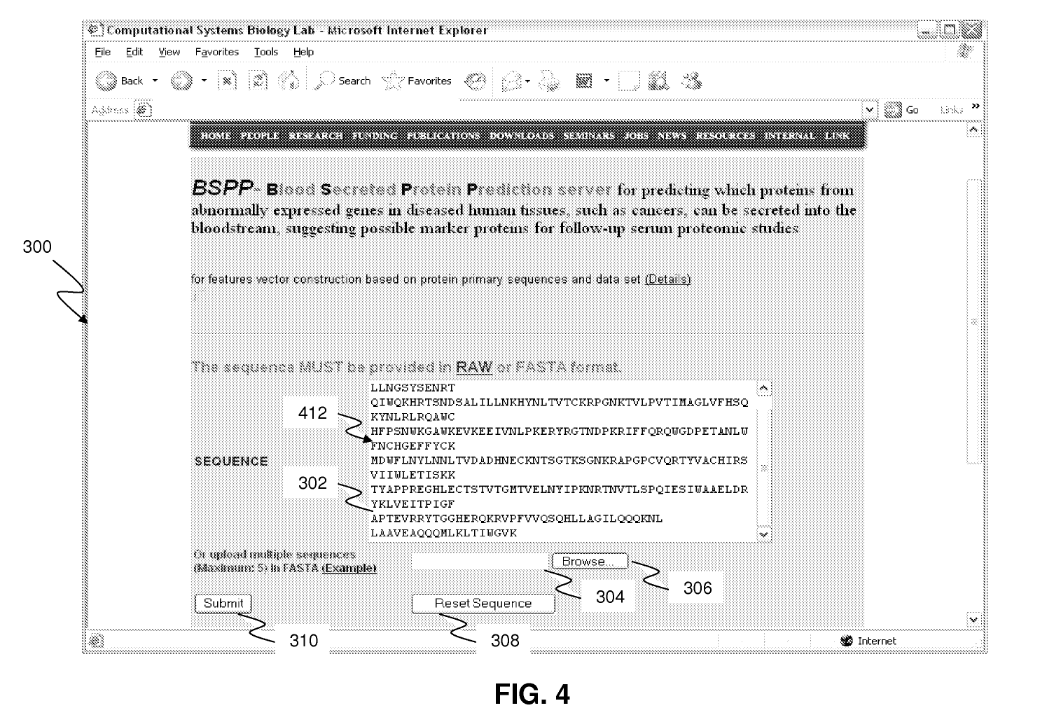

In one embodiment of the invention, the SVM-based classifier is further trained during step 111 to predict if abnormally and highly expressed genes, detected by microarray gene expression experiments, will have their proteins secreted into the bloodstream. Studies have identified a number of such genes that show abnormally high expression levels in patients of various pathological conditions, such as cancers. Armed with this knowledge, the SVM-based classifier can be used in step 121 to diagnose various cancers based upon calculating the probability that certain proteins will be excreted into a patient's bloodstream. In order to diagnose pathological conditions, such as cancer, in an embodiment, step 111 can use the second feature set corresponding to one or more pathological conditions, which is constructed in step 109 as described above. As shown in Table 7, a total of 26 and 57 genes were found to have abnormal expression levels, including both up-regulated and down-regulated in comparison with normal, non-cancerous cells from studies on gastric cancer and lung cancer, respectively. A study related to gastric cancer is described in Kim et al. (2002) and a study related to lung cancer is presented in Lo et al. (2007) For example, FIG. 4 (B) of Lo et al. (2007) illustrates the hierarchical clustering of gene expression alterations in squamous cell carcinoma (SqCC) compared to normal tissue. As discussed in Lo et al. (2007), genes have been identified as potential markers for cancer diagnosis or for distinguishing different cancer stages. In one embodiment of the present invention, a classifier is run on each of genes listed in Table 2 of Lo et al. (2007) to check if its encoded protein is predicted to be blood-secreted and thus can possibly serve as bio-markers for the corresponding cancer. The prediction results show that 13 and 31 proteins out of the 26 and 57 proteins, respectively, can be secreted into the bloodstream. For example, complement factor D is encoded by the CFD gene. According to a quantitative analysis of factor D secretion by gastric cancer cells (Kitano and Kitamura, 2002), factor D secreted by gastric tissues is considered to likely contribute to the factor D level in blood circulation, which is consistent with the prediction. Another example is the multi-drug and toxin extrusion protein 2, encoded by gene MATE1 with elevated expression in gastric cancer patients. It is a solute transporter for tetraethylammonium (TEA), 1-methyl-4-phenylpyridinium (MPP), cimetidine, and ganciclovir, and directly transports toxic organic cations (OCs) into urine and bile (Otsuka et al., 2005). Members of the MATE families have been observed on the surface of various tissue cells including endothelial cells of blood vessels. For example, Pardo et al. (2007) describes biomarker discovery from uveal melanoma secretomes and the identification of gp100 and cathepsin D in serum. Thus, the prediction of these proteins as being blood-secreted is consistent with prior studies.

According to an embodiment, based on the results on multiple data sets presented above, the overall prediction accuracy of predictions produced in step 121 by the SVM-based classifier ranges from 79.5% to 98.1%, with at least 80% of known blood-secreted proteins correctly predicted for both independent evaluation test and the extra blood proteins test. From the independent negative evaluation test, the false positive rate is found to be ˜10%, a reasonable percentage of misclassified non-blood-secreted proteins, which is helpful in alleviating the doubts associated with low precision. The prediction accuracies for predictions produced in step 121 have shows a good level of consistency across different data sets.

It should be noted that several factors can affect the accuracy of the prediction. One is the diversity of protein samples used for training the SVM-based classifier. It is possible that not all possible types of bodily fluid-secreted proteins are adequately represented in the training set. For example, the current limitations in the proteomic technologies for precise separation, detection and identification of relevant proteins might explain why some of the proteins with relatively low abundance (lower than ng/ml in serum) are not detected when in the presence of the high abundance native blood proteins (greater than mg/ml in serum). This apparent discrepancy can be overcome with the accumulation of more proteins identified through more cancer studies focusing on proteins with low abundance in blood. Another potential problem is that the protein secretion mechanisms may not be sufficiently represented by the structural and physicochemical descriptors used in the trained classifier produced in step 115, leading to false predictions in step 121. Additional and more informative descriptors (features) can be mapped through iterations of steps 109 and 114 to alleviate this problem. After the protein class is predicted in step 121, an output sequence corresponding to the prediction is created and the method continues to step 123.

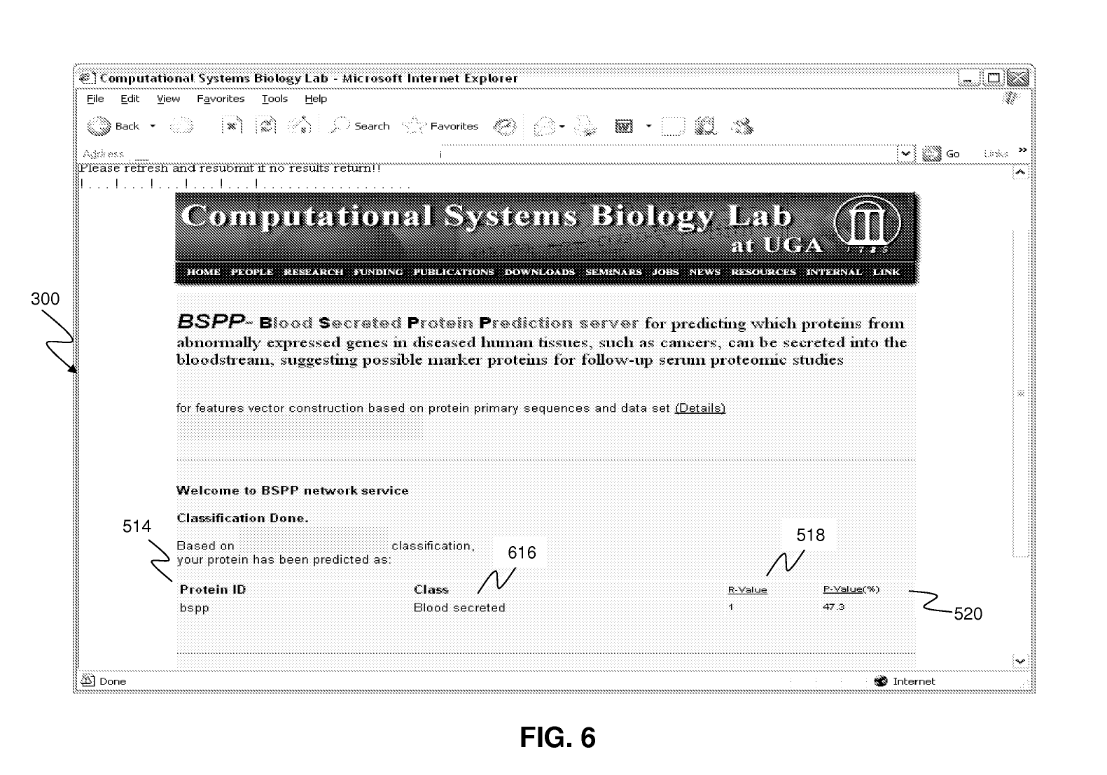

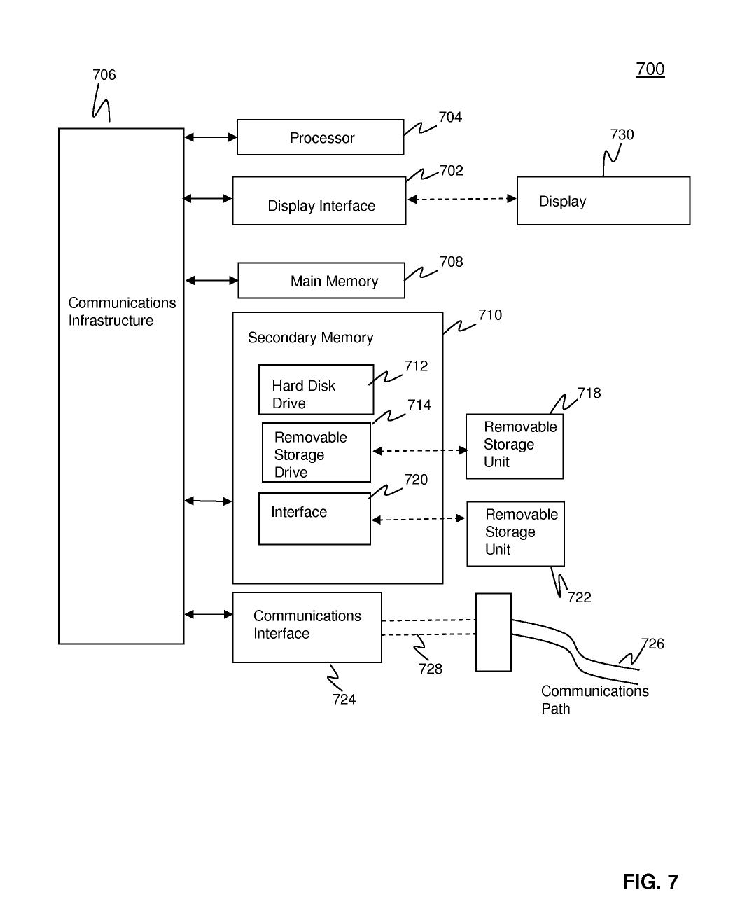

In step 123, based on the output sequence created in step 121, R-values and P-values are presented and a prediction result is returned. According to one embodiment, the R-value, P-value, and prediction results are presented in a graphical user interface (GUI) such as GUI 300 depicted in FIGS. 6 and 7, which are described in detail below. In other embodiments, the prediction result may be presented as a chart, table, printout, email alert, voicemail message, or as an icon in a GUI (i.e., a red graphic icon indicating a negative result and a green icon indicating a positive result). In one embodiment of the invention, the prediction result may be presented in standalone mode without the corresponding R and P-values. After the result is presented in step 123, method 100 ends.

Although the foregoing description of the steps of method 100 discuss embodiments related to predicting secretion of proteins into the bloodstream, based upon the foregoing discussion, it is understood that the steps of method 100 can be applied to additional bodily fluids such as, but not limited to saliva, urine spinal fluid, seminal fluid, vaginal fluid, amniotic fluid, gingival crevicular fluid, and ocular fluid. In particular, the above-described steps 103-123 can be adapted to predict secretion of proteins into other bodily fluids besides blood. It is understood that the steps of selecting a positive, secreted class of proteins; selecting representative proteins for a negative set; mapping protein features to construct a feature set; training a classifier to recognize characteristics of classes of proteins; determining accuracy and relevancy of mapped features; removing the least important features to produce a re-trained classifier; receiving protein sequences; vector generation and scaling; predicting classes for the received protein sequences; and returning a prediction result for the received protein sequences can be readily adapted to a method for predicting secretion of other biological fluids besides blood. An exemplary implementation of applying method 100 to protein analysis for urine is provided in the following section.

TABLE 5
Performance statistics of five classifiers on prediction of blood-secreted
protein and non-blood-secreted proteins independent evaluation set.

| | Sigma* | Blood-secreted | | | Non-blood-secreted | | | | | | |
|---|---|---|---|---|---|---|---|---|---|---|---|
| Classifier | (C = 10000) | TP | FN | SE (%) | TN | FP | SP (%) | Q (%) | P (%) | MCC | AUC |
| C1 | 1.15 | 41 | 6 | 87.2 | 3,249 | 47 | 98.6 | 98.4 | 46.6 | 0.63 | 0.93 |
| C2 | 1.05 | 44 | 3 | 93.6 | 3,237 | 59 | 98.2 | 98.1 | 42.7 | 0.63 | 0.95 |
| C3 | 1.35 | 42 | 5 | 89.4 | 3,244 | 52 | 98.4 | 98.3 | 44.7 | 0.63 | 0.94 |
| C4 | 1.25 | 41 | 6 | 87.2 | 3,249 | 47 | 98.6 | 98.4 | 46.6 | 0.63 | 0.93 |
| C5 | 1.05 | 44 | 3 | 93.7 | 3,237 | 59 | 98.2 | 98.1 | 42.7 | 0.63 | 0.95 |
| Average | | | | 90.2 | | | 98.4 | 98.3 | 44.6 | 0.63 | 0.94 |

*sigma: the kernel width; C: the penalty parameter, which is the trade-off between training errors and the margins. Each classifier is obtained based on the best sensitivity through scanning the parameter sigma from 0.05 to 1000.

TABLE 6
List of differentially-expressed serum proteins and the status of SVM prediction.

| | Protein | Description of function, subcelullar | Cancer | Prediction | | | |
|---|---|---|---|---|---|---|---|
| Protein name | AC | location or tissue expression | type | class | R-value | P-value | status |
| transcriptional | P49711 | Transcriptional repressor binding | Ovarian | − | 2.1 | 64.0% | C |
| repressor CTCF | | to promoters of vertebrate c-myc | cancer | | | | |
| | | gene; Nucleus | | | | | |
| Tissue-type | P00750 | EC 3.4.21.68 t-plasminogen | Renal | + | 2.8 | 88.4% | C |
| plasminogen | | activator; Secreted, extracellular | cancer | | | | |
| activator | | space; Synthesized in numerous | | | | | |
| | | tissues (including tumors) and | | | | | |
| | | secreted into most extracellular | | | | | |
| | | body fluids, such as plasma, | | | | | |
| | | uterine fluid, saliva, gingival | | | | | |
| | | crevicular fluid | | | | | |
| Tumor necrosis | P98066 | Possibly involved in cell-cell and | Lung | + | 2.8 | 88.4% | C |
| factor-inducible | | cell-matrix interactions during | cancer | | | | |
| protein TSG-6 | | inflammation and | | | | | |
| | | tumorigenesis; found in the | | | | | |
| | | synovial fluid of patients with | | | | | |
| | | rheumatoid arthritis | | | | | |
| Tumor necrosis | P01375 | Single-pass type II membrane | Prostate | + | 2.8 | 88.4% | C |
| factor | | protein; Soluble form; Secreted | cancer | | | | |
| Thymidine | P19971 | EC 2.4.2.4 Platelet-derived | Renal | − | 2.8 | 88.4% | NC |
| phosphorylase/P | | endothelial cell growth factor; | cancer | | | | |
| D-ECGF | | May have a role in maintaining | | | | | |
| | | the integrity of the blood vessels | | | | | |
| Thrombospondin | P07996 | Adhesive glycoprotein that | Melanoma | + | 2.3 | 70.3% | PC |
| 1 precursor | | mediates cell-to-cell and cell-to- | | | | | |
| | | matrix interactions | | | | | |
| TFIIH basal | P32780 | Nucleus; Component of the core- | Pancreatic | − | 2.9 | 90.3% | C |
| transcription | | TFIIH basal transcription factor | cancer | | | | |
| factor complex | | | | | | | |
| p62 subunit | | | | | | | |
| Tenascin | P24821 | Glioma-associated-extracellular | Melanoma | + | 2.8 | 88.4% | C |
| | | matrix antigen; Secreted | | | | | |
| TATA-binding | O14981 | EC 3.6.1.-ATP-dependent | Ovarian | − | 2.8 | 88.4% | C |
| protein- | | helicase BTAF1; Regulates | cancer | | | | |
| associated factor 172 | | transcription in association with | | | | | |
| | | TATA binding protein; Nucleus | | | | | |
| Syntenin-1 | O00560 | In adherens junctions may | Melanoma | − | 2.8 | 88.4% | NC |
| | | function to couple syndecans to | | | | | |
| | | cytoskeletal proteins or signaling | | | | | |
| | | components; Mainly membrane- | | | | | |
| | | associated. | | | | | |
| U6 snRNA- | O15116 | Small nuclear ribonuclear CaSm | HCC | − | 2.8 | 88.4% | C |
| associated Sm- | | Cancer-associated Sm-like; | | | | | |
| like protein | | Nucleus | | | | | |
| LSm1 | | | | | | | |
| Semaphorin-5A | Q13591 | May act as positive axonal | Melanoma | + | 2.8 | 88.4% | C |
| | | guidance cues; Membrane; | | | | | |
| | | Single-pass type I membrane | | | | | |
| | | protein | | | | | |
| Ribosome- | Q9P2E9 | Acts as a ribosome receptor and | Ovarian | + | 2.1 | 64.0% | NC |
| binding protein 1 | | mediates interaction between the | cancer | | | | |
| | | ribosome and the endoplasmic | | | | | |
| | | reticulum membrane; Single-pass | | | | | |
| | | type III membrane protein | | | | | |
| Ras-related | P62834 | Induces morphological reversion | Melanoma | − | 2.8 | 88.4% | NC |
| protein Rap-1A | | of a cell line transformed by a | | | | | |
| | | Ras oncogene; Cell membrane | | | | | |
| C-C motif | P13501 | Chemoattractant for blood | Gastric | + | 2.8 | 88.4% | C |
| chemokine 5 | | monocytes, memory T-helper | cancer | | | | |
| | | cells and eosinophils; Causes the | | | | | |
| | | release of histamine from | | | | | |
| | | basophils and activates | | | | | |
| | | eosinophils | | | | | |
| DNA repair | Q92878 | EC 3.6.-.- hRAD50; Component | Ovarian | + | 2.8 | 88.4% | NC |
| protein RAD50 | | of the MRN complex, which | cancer | | | | |
| | | plays a central role in double- | | | | | |
| | | strand break (DSB) repair, DNA | | | | | |
| | | recombination | | | | | |
| Prostate-specific | Q9HBA9 | Nucleus; Kidney and liver; Not | Prostate | − | 2.8 | 88.4% | C |
| membrane | | expressed in the prostate | cancer | | | | |
| antigen-like | | | | | | | |
| protein | | | | | | | |
| Prostate stem | O43653 | Cell membrane; Lipid-anchor, | Prostate | − | 2.7 | 82.0% | NC |
| cell antigen | | GPI-anchor; Highly expressed in | cancer | | | | |
| | | prostate (basal, secretory and | | | | | |
| | | neuroendocrine epithelium cells). | | | | | |
| Prostate-specific | P07288 | EC 3.4.21.77 Semenogelase; | Prostate | + | 2.8 | 88.4% | C |
| antigen | | Secreted | cancer | | | | |
| | | | bladder | | | | |
| | | | cancer | | | | |
| Protein DJ-1 | Q99497 | Oncogene DJ1; Acts as a positive | Melanoma | − | 2.8 | 88.4% | C |
| | | regulator of androgen receptor- | lung | | | | |
| | | dependent transcription; Nucleus | bladder | | | | |
| | | | cancer | | | | |
| protein | Q969H8 | Stromal cell-derived growth | Melanoma | + | 2.8 | 88.4% | C |
| C19orf10 (IL-25) | | factor SF20; Interleukin-25; | | | | | |
| | | Secreted | | | | | |
| Prostatic acid | P15309 | EC 3.1.3.2; Secretion | Prostate | + | 2.8 | 88.4% | C |
| phoshatase | | | cancer | | | | |
| Proliferating | Q6FI35 | Involved in the control of | Uterine | − | 3.2 | 96.1% | C |
| cell nuclear | | eukaryotic DNA replication by | cervix | | | | |
| antigen | | increasing the polymerase's | cancer | | | | |
| | | processibility during elongation | | | | | |
| | | of the leading strand; Nucleus | | | | | |
| Prohibitin | P35232 | Prohibitin inhibits DNA | Gastric | + | 2.7 | 82.0% | NC |
| | | synthesis; It has a role in | cancer | | | | |
| | | regulating proliferation; | | | | | |
| | | Mitochondrion inner membrane | | | | | |
| Programmed | Q8WUM4 | Involved in concentration and | Melanoma | − | 2.8 | 88.4% | C |
| cell death 6- | | sorting of cargo proteins of the | | | | | |
| interacting | | multivesicular body (MVB) for | | | | | |
| protein | | incorporation into intralumenal | | | | | |
| | | vesicles; Cytoplasm, cytosol | | | | | |
| Profilin-1 | P07737 | Binds to actin and affects the | Melanoma | − | 2.8 | 88.4% | NC |
| | | structure of the cytoskeleton. At | | | | | |
| | | high concentrations, profilin | | | | | |
| | | prevents the polymerization of | | | | | |
| | | actin; Secretion | | | | | |
| Probable ATP- | P17844 | EC 3.6.1.- RNA-dependent | Ovarian | − | 2.8 | 88.4% | C |
| dependent RNA | | ATPase activity; Nucleus | cancer | | | | |
| helicase DDX5 | | | | | | | |
| Plakophilin-2 | Q99959 | May play a role in junctional | Ovarian | − | 2.8 | 88.4% | C |
| | | plaques; Nuclear and associated | cancer | | | | |
| | | with desmosomes | | | | | |
| Peroxiredoxin-5, | P30044 | EC 1.11.1.15 Peroxisomal | Gastric | − | 2.8 | 88.4% | C |
| mitochondrial | | antioxidant enzyme; Reduces | cancer | | | | |
| | | hydrogen peroxide and alkyl | | | | | |
| | | hydroperoxides with reducing | | | | | |
| | | equivalents provided through the | | | | | |
| | | thioredoxin system; | | | | | |
| | | Mitochondrion. Cytoplasm. | | | | | |
| Peptidyl-prolyl | P23284 | EC 5.2.1.8 Rotamase; PPIases | Melanoma; | + | 2.8 | 88.4% | NC |
| cis-trans | | accelerate the folding of proteins. | lung; | | | | |
| isomerase B | | It catalyzes the cis-trans | bladder | | | | |
| | | isomerization of proline imidic | cancer | | | | |
| | | peptide bonds in oligopeptides; | | | | | |
| | | Endoplasmic reticulum lumen | | | | | |
| PC-3 secreted | Q1L6U9 | Secreted microprotein | Prostate | + | 3.2 | 96.1% | C |
| microprotein | | | cancer | | | | |
| Transient | O94759 | EC 3.6.1.13; Long transient | Prostate | − | 2.8 | 88.4% | C |
| receptor | | receptor potential channel 2 | cancer | | | | |
| potential cation | | | | | | | |
| channel | | | | | | | |
| subfamily M | | | | | | | |
| member 2 | | | | | | | |
| Cellular tumor | P04637 | Involved in cell cycle regulation | Bladder | − | 2.8 | 88.4% | C |
| antigen p53 | | as a trans-activator that acts to | cancer | | | | |
| | | negatively regulate cell division | | | | | |
| | | by controlling a set of genes | | | | | |
| | | required for this process; | | | | | |
| | | Cytoplasm. Nucleus | | | | | |
| Triosephosphate | P60174 | EC 5.3.1.1 TIM Triose-phosphate | Renal | − | 2.3 | 70.3% | PC |
| isomerase | | isomerase | cancer | | | | |
| Nucleoside | P15531 | EC 2.7.4.6 NDP kinase A; Major | Melanoma | − | 2.8 | 88.4% | C |
| diphosphate | | role in the synthesis of nucleoside | | | | | |
| kinase A | | triphosphates other than ATP; | | | | | |
| | | Cytoplasm. Nucleus | | | | | |
| Nucleophosmin | P06748 | Associated with nucleolar | Melanoma | − | 2.8 | 88.4% | C |
| | | ribonucleoprotein structures and | | | | | |
| | | bind single-stranded nucleic | | | | | |
| | | acids; Nucleus | | | | | |
| Zinc finger | Q14966 | Binds to cytidine clusters in | Ovarian | + | 2.8 | 88.4% | NC |
| protein 638 | | double-stranded DNA; Nucleus | cancer | | | | |
| | | speckle | | | | | |
| Gamma-enolase | P09104 | EC 4.2.1.11 Neuron-specific | Melanoma | − | 2.8 | 88.4% | C |
| | | enolase; Cytoplasm | | | | | |
| Neural cell | P32004 | Cell adhesion molecule with an | Melanoma | − | 2.3 | 70.3% | NC |
| adhesion | | important role in the development | | | | | |
| molecule L1 | | of the nervous system; Cell | | | | | |
| | | membrane; Single-pass type I | | | | | |
| | | membrane protein | | | | | |
| Myotubularin | Q13496 | EC 3.1.3.48 Dual-specificity | HCC | − | 2.8 | 88.4% | PC |
| | | phosphatase that acts on both | | | | | |
| | | phosphotyrosine and | | | | | |
| | | phosphoserine | | | | | |
| Myoglobin | P02144 | Serves as a reserve supply of | Uterine | − | 2.8 | 88.4% | NC |
| | | oxygen and facilitates the | cervix | | | | |
| | | movement of oxygen within | cancer | | | | |
| | | muscles; Secretion | | | | | |
| Myelin basic | P02686 | Myelin membrane | Brain | − | 2.8 | 88.4% | NC |
| protein | | encephalitogenic protein; Myelin | cancer | | | | |
| | | membrane; Peripheral membrane | | | | | |
| | | protein | | | | | |
| Mucin-1 | P15941 | Tumor-associated epithelial | Bladder | + | 2.8 | 88.4% | C |
| | | membrane antigen; Can act both | cancer | | | | |
| | | as an adhesion and an anti- | | | | | |
| | | adhesion protein. May provide a | | | | | |
| | | protective layer on epithelial cells | | | | | |
| | | against bacterial and enzyme | | | | | |
| | | attack | | | | | |
| Moesin | P26038 | Probably involved in connections | Melanoma | − | 2.8 | 88.4% | C |
| | | of major cytoskeletal structures to | | | | | |
| | | the plasma membrane; Cytoplasm | | | | | |
| Superoxide | P04179 | EC 1.15.1.1 Destroys radicals | Melanoma | − | 2.8 | 88.4% | NC |
| dismutase [Mn], | | which are normally produced | | | | | |
| mitochondrial | | within the cells and which are | | | | | |
| | | toxic to biological systems | | | | | |
| C-C motif | P10147 | Monokine with inflammatory and | ovarian | + | 2.9 | 90.3% | C |
| chemokine 3 | | chemokinetic properties; | cancer | | | | |
| | | Secretion | | | | | |
| Midasin | Q9NU22 | May function as a nuclear | Ovarian | − | 2.8 | 88.4% | C |
| | | chaperone and be involved in the | cancer | | | | |
| | | assembly/disassembly of | | | | | |
| | | macromolecular complexes in the | | | | | |
| | | nucleus | | | | | |
| Microtubule- | P78559 | Structural protein involved in the | Ovarian | + | 2.8 | 88.4% | PC |
| associated | | filamentous cross-bridging | cancer | | | | |
| protein 1A | | between microtubules and other | | | | | |
| | | skeletal elements | | | | | |
| Metalloproteinase | P16035 | Complexes with | Ovarian | + | 2.9 | 90.3% | C |
| inhibitor 2 | | metalloproteinases (such as | cancer | | | | |
| | | collagenases) and irreversibly | | | | | |
| | | inactivates them; Secretion | | | | | |
| Melanoma- | Q16674 | Elicits growth inhibition on | Melanoma; | + | 2.9 | 90.3% | C |
| derived growth | | melanoma cells in vitro as well as | lung | | | | |
| regulatory | | some other neuroectodermal | | | | | |
| protein | | tumors, including gliomas; | | | | | |
| | | Secretion | | | | | |
| Melanocyte | P40967 | Could be a melanogenic enzyme; | Melanoma | + | 2.9 | 90.3% | C |
| protein Pmel 17 | | represent an oncofetal self- | | | | | |
| | | antigen that is normally expressed | | | | | |
| | | at low levels in quiescent adult | | | | | |
| | | melanocytes but overexpressed | | | | | |
| | | by proliferating neonatal | | | | | |
| | | melanocytes and during tumor | | | | | |
| | | growth; Secretion | | | | | |
| Major vault | Q14764 | Required for normal vault | Renal | − | 2.8 | 88.4% | NC |
| protein | | structure; Present in most normal | cancer | | | | |
| | | tissues. Higher expression | | | | | |
| | | observed in epithelial cells with | | | | | |
| | | secretory and excretory functions | | | | | |
| Macrophage | P14174 | The expression of MIF at sites of | Melanoma | − | 2.8 | 88.4% | NC |
| migration | | inflammation suggest a role for | | | | | |
| inhibitory factor | | the mediator in regulating the | | | | | |
| | | function of macrophage in host | | | | | |
| | | defense | | | | | |
| Lysosomal | P10619 | Protective protein appears to be | Melanoma | + | 2.8 | 88.4% | PC |
| protective | | essential for both the activity of | | | | | |
| protein | | beta-galactosidase and | | | | | |
| | | neuraminidase, it associates with | | | | | |
| | | these enzymes and exerts a | | | | | |
| | | protective function necessary for | | | | | |
| | | their stability and activity; in | | | | | |
| | | lysosome | | | | | |
| L-lactate | P07195 | Member of the lactate | Renal | − | 2.8 | 88.4% | C |
| dehydrogenase | | dehydrogenase enzyme family, | cancer; | | | | |
| chain H | | which catalyzes the conversion of | bladder | | | | |
| | | lactate to pyruvate; Renal | cancer | | | | |
| | | carcinoma antigen NY-REN-46; | | | | | |
| | | Cytoplasm | | | | | |
| Legumain | Q99538 | EC 3.4.22.34 Asparaginyl | Melanoma; | + | 2.9 | 90.3% | C |
| | | endopeptidase; May be involved | lung | | | | |
| | | in the processing of proteins for | | | | | |
| | | MHC class II antigen presentation | | | | | |
| | | in the lysosomal/endosomal | | | | | |
| | | system; Secretion | | | | | |
| Laminin subunit | P55268 | Binding to cells via a high affinity | Melanoma | + | 3.2 | 96.1% | C |
| beta-2 | | receptor, laminin is thought to | | | | | |
| | | mediate the attachment, migration | | | | | |
| | | and organization of cells into | | | | | |
| | | tissues during embryonic | | | | | |
| | | development by interacting with | | | | | |
| | | other extracellular matrix | | | | | |
| | | components; Secretion | | | | | |
| Lamin-A/C | P02545 | Components of the nuclear | Melanoma | − | 2.8 | 88.4% | C |
| | | lamina, provide a framework for | | | | | |
| | | the nuclear envelope and may | | | | | |
| | | also interact with chromatin; | | | | | |
| | | Nucleus | | | | | |
| Lactadherin | Q08431 | Milk fat globule-EGF factor 8; | Melanoma | + | 2.8 | 88.4% | PC |
| | | Peripheral membrane protein | | | | | |
| Insulin-like | O00425 | RNA-binding protein that act as a | bladder | − | 2.8 | 88.4% | C |
| growth factor 2 | | regulator of mRNA translation | cancer | | | | |
| mRNA-binding | | and stability; Nucleus, Cytoplasm | | | | | |
| protein 3 | | | | | | | |
| Keratin, type I | P13645 | Seen in all suprabasal cell layers | Pancreatic | − | 2.1 | 64.0% | NC |
| cytoskeletal 10 | | including stratum corneum, | cancer | | | | |
| | | Secretion | | | | | |
| Interleukin-8 | P10145 | A chemotactic factor that attracts | Breast | + | 2.2 | 68.0% | C |
| | | neutrophils, basophils, and T- | cancer | | | | |
| | | cells, but not monocytes; | | | | | |
| | | Secretion. | | | | | |
| Interleukin-5 | P05113 | Factor that induces terminal | Cervical | + | 2.2 | 68.0% | C |
| | | differentiation of late-developing | Cancer | | | | |
| | | B-cells to immunoglobulin | | | | | |
| | | secreting cells; Secretion | | | | | |
| Interleukin-4 | P05112 | Participates in at least several B- | Pancreatic | + | 2.2 | 68.0% | C |
| | | cell activation processes as well | cancer | | | | |
| | | as of other cell types; Secretion | | | | | |
| Interleukin-2 | P60568 | Produced by T-cells in response | Kidney | + | 2.2 | 68.0% | C |
| | | to antigenic or mitogenic | cancer, | | | | |
| | | stimulation, this protein is | melanoma | | | | |
| | | required for T-cell proliferation | | | | | |
| | | and other activities crucial to | | | | | |
| | | regulation of the immune | | | | | |
| | | response; Secretion | | | | | |
| Interleukin-12 | P29459 | Cytokine that can act as a growth | Colon | + | 2.8 | 88.4% | C |
| subunit alpha | | factor for activated T and NK | cancer | | | | |
| | | cells; Secretion | | | | | |
| Interleukin-10 | P22301 | Inhibits the synthesis of a number | Breast | + | 2.8 | 88.4% | C |
| | | of cytokines, including IFN- | cancer | | | | |
| | | gamma, IL-2, IL-3, TNF; | | | | | |
| | | Secretion | | | | | |
| Interferon | P01579 | Produced by lymphocytes | Colorectal | + | 2.8 | 88.4% | C |
| gamma | | activated by specific antigens or | cancer | | | | |
| | | mitogens; Secteted | | | | | |
| Interferon | P01566 | Produced by macrophages, have | Bladder | + | 2.8 | 88.4% | C |
| alpha-10 | | antiviral activities; stimulates the | cancer | | | | |
| | | production of two enzymes: a | | | | | |
| | | protein kinase and an | | | | | |
| | | oligoadenylate synthetase; | | | | | |
| | | Secretion | | | | | |
| Insulin-like | Q16270 | Binds IGF-I and IGF-II with a | Melanoma | + | 2.8 | 88.4% | C |
| growth factor- | | relatively low affinity. Stimulates | | | | | |
| binding protein 7 | | prostacyclin (PGI2) production; | | | | | |
| | | Secretion | | | | | |
| Inner | Q9NQS7 | Component of the chromosomal | Ovarian | − | 2.2 | 68.0% | C |
| centromere | | passenger complex (CPC), acts as | cancer | | | | |
| protein | | a key regulator of mitosis; | | | | | |
| | | Centromere. Spindle | | | | | |
| Immunoglobulin | P11912 | Required in cooperation with | Prostate | + | 2.8 | 88.4% | PC |
| alpha chain C | | CD79B for initiation of the signal | cancer | | | | |
| | | transduction cascade activated by | | | | | |
| | | binding of antigen to the B-cell | | | | | |
| | | antigen receptor complex (BCR) | | | | | |
| | | which leads to internalization of | | | | | |
| | | the complex, trafficking to late | | | | | |
| | | endosomes and antigen | | | | | |
| | | presentation; Single-pass type I | | | | | |
| | | membrane protein | | | | | |
| Eosinophil | Q05315 | May have both lysophospholipase | Bladder | − | 2.8 | 88.4% | C |
| lysophospholipase | | and carbohydrate-binding | cancer | | | | |
| | | activities; Cytoplasmic granule | | | | | |
| Kallikrein-2 | P20151 | Glandular kallikreins cleave | Prostate | + | 2.8 | 88.4% | C |
| | | Met-Lys and Arg-Ser bonds in | cancer | | | | |
| | | kininogen to release Lys- | | | | | |
| | | bradykinin | | | | | |
| Serine protease | P05981 | Plays an essential role in cell | Prostate | − | 2.8 | 88.4% | NC |
| hepsin | | growth and maintenance of cell | cancer | | | | |
| | | morphology; Single-pass type II | | | | | |
| | | membrane protein. | | | | | |
| Hepatocyte | P08581 | Receptor for hepatocyte growth | Melanoma | + | 2.8 | 88.4% | PC |
| growth factor | | factor and scatter factor. Has a | | | | | |
| receptor | | tyrosine-protein kinase activity; | | | | | |
| | | Single-pass type I membrane | | | | | |
| | | protein | | | | | |
| Heat shock | P04792 | Involved in stress resistance and | Gastric cancer; | − | 2.9 | 90.3% | C |
| protein beta-1 | | actin organization; Cytoplasm. | breast cancer; | | | | |
| | | Nucleus. | bladder cancer | | | | |
| PH and SEC7 | Q9NYI0 | Guanine nucleotide exchange | HCC | − | 2.8 | 88.4% | C |
| domain- | | factor for ARF6; Cell junction, | | | | | |
| containing | | synapse, postsynaptic cell | | | | | |
| protein 3 | | membrane, postsynaptic density | | | | | |
| Calcineurin B | O43745 | Binds to and activates | HCC | − | 2.1 | 64.0% | NC |
| homologous | | SLC9A1/NHE1 in a serum- | | | | | |
| protein 2 | | independent manner, thus | | | | | |
| | | increasing pH and protecting cells | | | | | |
| | | from serum deprivation-induced | | | | | |
| | | death; Expressed in malignantly | | | | | |
| | | transformed cells but not detected | | | | | |
| | | in normal tissues. | | | | | |
| Targeting | Q9ULW0 | In nucleus, spindle; Expressed in | HCC | − | 2.8 | 88.4% | C |
| protein for | | lung carcinoma cell lines but not | | | | | |
| Xklp2 | | in normal lung tissues. | | | | | |
| Growth/ | Q99988 | Secreted; Highly expressed in | Melanoma | + | 2.8 | 88.4% | C |
| differentiation | | placenta, with lower levels in | | | | | |
| factor 15 | | prostate and colon and some | | | | | |
| | | expression in kidney | | | | | |
| Golgin | Q08378 | Golgi auto-antigen; probably | Ovarian | − | 2.8 | 88.4% | NC |
| subfamily A | | involved in maintaining Golgi | cancer | | | | |
| member 3 | | structure; Cytoplasm. Golgi | | | | | |
| | | apparatus, Peripheral membrane | | | | | |
| | | protein | | | | | |
| Glyceraldehyde- | P04406 | Independent of its glycolytic | Uterine | − | 2.7 | 82.0% | NC |
| 3-phosphate | | activity it is also involved in | cervix | | | | |
| dehydrogenase | | membrane trafficking in the early | cancer | | | | |
| | | secretory pathway; Cytoplasm, | | | | | |
| | | perinuclear region. Membrane | | | | | |
| Glycogen | P35573 | Multifunctional enzyme acting as | Ovarian | − | 2.8 | 88.4% | C |
| debranching | | 1,4-alpha-D-glucan: 1,4-alpha-D- | cancer | | | | |
| enzyme | | glucan 4-alpha-D- | | | | | |
| | | glycosyltransferase and amylo- | | | | | |
| | | 1,6-glucosidase in glycogen | | | | | |
| | | degradation | | | | | |
| Granulocyte- | P04141 | Cytokine that stimulates the | Pancreatic | + | 2.8 | 88.4% | C |
| macrophage | | growth and differentiation of | cancer | | | | |
| colony- | | hematopoietic precursor cells | | | | | |
| stimulating | | from various lineages, including | | | | | |
| factor | | granulocytes, macrophages, | | | | | |
| | | eosinophils and erythrocytes; | | | | | |
| | | Secretion | | | | | |
| Guanine | P62873 | Involved as a modulator or | Renal | − | 2.9 | 90.3% | C |
| nucleotide- | | transducer in various | cancer | | | | |
| binding protein | | transmembrane signaling systems | | | | | |
| G(I)/G(S)/G(T) | | | | | | | |
| subunit beta-1 | | | | | | | |
| Galectin-1 | P09382 | May regulate cell apoptosis and | Bladder | − | 2.8 | 88.4% | C |
| | | cell differentiation. Binds beta- | cancer | | | | |
| | | galactoside | | | | | |
| FKBP12- | P42345 | Acts as the target for the cell- | Ovarian | − | 2.8 | 88.4% | C |
| rapamycin | | cycle arrest and | cancer | | | | |
| complex- | | immunosuppressive effects of the | | | | | |
| associated | | FKBP12-rapamycin complex | | | | | |
| protein | | | | | | | |
| Complement | P09871 | C1s B chain is a serine protease | HCC | + | 2.9 | 90.3% | C |
| C1s | | that combines with C1q and C1s | | | | | |
| subcomponent | | to form C1, the first component | | | | | |
| | | of the classical pathway of the | | | | | |
| | | complement system; Secretion | | | | | |
| Fatty acid- | Q01469 | Cytoplasm; highly expressed in | Bladder | − | 2.8 | 88.4% | C |
| binding protein, | | psoriatic skin | cancer | | | | |
| epidermal | | | | | | | |
| Eukaryotic | Q04637 | Component of the protein | Ovarian | − | 2.8 | 88.4% | C |
| translation | | complex eIF4F, which is involved | cancer | | | | |
| initiation factor | | in the recognition of the mRNA | | | | | |
| 4 gamma 1 | | cap, ATP-dependent unwinding | | | | | |
| | | of 5′-terminal secondary structure | | | | | |
| | | and recruitment of mRNA to the | | | | | |
| | | ribosome | | | | | |
| Receptor | P04626 | Essential component of a | Bladder | − | 2.8 | 88.4% | NC |
| tyrosine-protein | | neuregulin-receptor complex, | cancer | | | | |
| kinase erbB-2 | | although neuregulins do not | | | | | |
| | | interact with it alone; Membrane; | | | | | |
| | | Single-pass type I membrane | | | | | |
| | | protein. | | | | | |
| Epithelial | P12830 | Cadherins are calcium-dependent | Prostate | + | 2.8 | 88.4% | C |
| cadherin | | cell adhesion proteins. They | cancer | | | | |
| | | preferentially interact with | | | | | |
| | | themselves in a homophilic | | | | | |
| | | manner in connecting cells; | | | | | |
| | | Contribute to the sorting of | | | | | |
| | | heterogeneous cell typesCell | | | | | |
| | | junction. Cell membrane; Single- | | | | | |
| | | pass type I membrane protein | | | | | |
| Death-inducer | Q9BTC0 | Putative transcription factor, | Ovarian | + | 2.8 | 88.4% | C |
| obliterator 1 | | weakly pro-apoptotic when | cancer | | | | |
| | | overexpressed; Cytoplasm; | | | | | |
| | | Nucleus | | | | | |
| Eukaryotic | P38919 | Binds to spliced mRNAs and is | Pancreatic | − | 2.8 | 88.4% | C |
| initiation factor | | involved in nonsense-mediated | cancer; | | | | |
| 4A-III | | decay of mRNAs containing | bladder | | | | |
| | | premature stop codons; Nucleus | cancer | | | | |
| Peroxisomal | O75521 | Hepatocellular carcinoma- | HCC | − | 2.8 | 88.4% | C |
| 3,2-trans-enoyl- | | associated antigen 88; | | | | | |
| CoA isomerase | | Peroxisome matrix | | | | | |
| Keratin, type II | P05787 | Together with KRT19, helps to | Bladder | − | 2.2 | 68% | C |
| cytoskeletal 8 | | link the contractile apparatus to | cancer | | | | |
| | | dystrophin at the costameres of | | | | | |
| | | striated muscle; Cytoplasm | | | | | |
| Cullin-7 | Q14999 | Component of a probable SCF- | Ovarian | − | 2.8 | 88.4% | C |
| | | like E3 ubiquitin-protein ligase | cancer | | | | |
| | | complex, which mediates the | | | | | |
| | | ubiquitination and subsequent | | | | | |
| | | proteosomal degradation of target | | | | | |
| | | proteins; Cytoplasm | | | | | |
| Complement | P00736 | C1r B chain is a serine protease | Pancreatic | + | 2.8 | 88.4% | C |
| C1r | | that combines with C1q and C1s | cancer | | | | |
| subcomponent | | to form C1, the first component | | | | | |
| | | of the classical pathway of the | | | | | |
| | | complement system | | | | | |
| Coagulation | P05160 | The B chain of factor XIII is not | Pancreatic | + | 2.9 | 90.3% | C |
| factor XIII B | | catalytically active, but is thought | cancer | | | | |
| chain | | to stabilize the A subunits and | | | | | |
| | | regulate the rate of | | | | | |
| | | transglutaminase formation by | | | | | |
| | | thrombin; Secretion | | | | | |
| Myc proto- | P01106 | Participates in the regulation of | bladder | − | 2.8 | 88.4% | C |
| oncogene | | gene transcription. Binds DNA | cancer | | | | |
| protein | | both in a non-specific manner and | | | | | |
| | | also specifically to recognizes the | | | | | |
| | | core sequence 5′-CAC[GA]TG-3′; | | | | | |
| | | Nucleus | | | | | |
| Choriogonadotropin | P01233 | Stimulates the ovaries to | Testicular | + | 2.8 | 88.4% | C |
| subunit | | synthesize the steroids that are | cancer | | | | |
| beta | | essential for the maintenance of | | | | | |
| | | pregnancy; Secretion | | | | | |
| Chromogranin-A | P10645 | Pancreastatin strongly inhibits | Prostate | + | 2.2 | 68.0% | C |
| | | glucose induced insulin release | cancer | | | | |
| | | from the pancreas; Secretion | | | | | |
| Centromere | P49454 | Probably required for kinetochore | HCC | + | 2.3 | 70.3% | C |
| protein F | | function, involved in | | | | | |
| | | chromosome segregation during | | | | | |
| | | mitosis. Interacts with | | | | | |
| | | retinoblastoma protein (RB), | | | | | |
| | | CENP-E and BUBR1; Nucleus | | | | | |
| | | matrix | | | | | |
| Cell surface | P43121 | Plays a role in cell adhesion, and | Melanoma | + | 2.8 | 88.4% | C |
| glycoprotein | | in cohesion of the endothelial | | | | | |
| MUC18 | | monolayer at intercellular | | | | | |
| | | junctions in vascular tissue; | | | | | |
| | | Single-pass type I membrane | | | | | |
| | | protein | | | | | |
| Cation- | P11717 | Transport of phosphorylated | Melanoma | + | 2.8 | 88.4% | PC |
| independent | | lysosomal enzymes from the | | | | | |
| mannose-6- | | Golgi complex and the cell | | | | | |
| phosphate | | surface to lysosomes; Single-pass | | | | | |
| receptor | | type I membrane protein | | | | | |
| Cathepsin Z | Q9UBR2 | Exhibits carboxy-monopeptidase | Melanoma | + | 3.2 | 96.1% | C |
| | | and carboxy-dipeptidase activity; | | | | | |
| | | Secretion | | | | | |
| Cathepsin L1 | P07711 | Important for the overall | Melanoma | + | 2.8 | 88.4% | C |
| | | degradation of proteins in | | | | | |
| | | lysosomes; Secretion | | | | | |
| Cathepsin D | P07339 | Acid protease active in | Breast | + | 2.8 | 88.4% | C |
| | | intracellular protein breakdown. | cancer | | | | |
| | | Involved in the pathogenesis of | Melanoma | | | | |
| | | several diseases such as breast | | | | | |
| | | cancer and possibly Alzheimer | | | | | |
| | | disease | | | | | |
| Cathepsin B | P07858 | Thiol protease which is believed | Melanoma | + | 2.8 | 88.4% | C |
| | | to participate in intracellular | | | | | |
| | | degradation and turnover of | | | | | |
| | | proteins. Has also been | | | | | |
| | | implicated in tumor invasion and | | | | | |
| | | metastasis | | | | | |
| Carcinoembryonic | P06731 | Cell membrane; Lipid-anchor; | Gastric | + | 2.8 | 88.4% | C |
| antigen- | | Found in adenocarcinomas of | cancer | | | | |
| related cell | | endodermally derived digestive | | | | | |
| adhesion | | system epithelium and fetal colon | | | | | |
| molecule 5 | | | | | | | |
| Carbonic | P00915 | Reversible hydration of carbon | Renal | − | 3.2 | 96.1% | NC |
| anhydrase 1 | | dioxide; Cytoplasm; Secretion | cancer | | | | |
| Calsyntenin-1 | O94985 | May modulate calcium-mediated | Melanoma | + | 2.8 | 88.4% | PC |
| | | postsynaptic signals; Cell | | | | | |
| | | membrane; Single-pass type I | | | | | |
| | | membrane protein | | | | | |
| Beta- | P16278 | Cleaves beta-linked terminal | Uterine | + | 2.8 | 88.4% | C |
| galactosidase | | galactosyl residues from | cervix | | | | |
| | | gangliosides, glycoproteins, and | cancer | | | | |
| | | glycosaminoglycans; Lysosome | | | | | |
| ATP-binding | Q99758 | Plays an important role in the | Ovarian | + | 2.8 | 88.4% | C |
| cassette sub- | | formation of pulmonary | cancer | | | | |
| family A | | surfactant, probably by | | | | | |
| member 3 | | transporting lipids such as | | | | | |
| | | cholesterol | | | | | |
| Apolipoprotein | Q8NCW5 | Secreted; Present in cerebrospinal | Pancreatic | + | 2.8 | 88.4% | C |
| A-I-binding | | fluid and urine but not in serum | cancer | | | | |
| protein | | from healthy patients; Present in | | | | | |
| | | serum of sepsis patients | | | | | |
| Annexin A5 | P08758 | Acts as an indirect inhibitor of the | Bladder | − | 2.8 | 88.4% | NC |
| | | thromboplastin-specific complex, | cancer; | | | | |
| | | which is involved in the blood | Melanoma | | | | |
| | | coagulation cascade | | | | | |
| Alpha- | Q9UHK6 | Racemization of 2-methyl- | Prostate | − | 2.7 | 82.0% | NC |
| methylacyl-CoA | | branched fatty acid CoA esters. | cancer | | | | |
| racemase | | Responsible for the conversion of | | | | | |
| | | pristanoyl-CoA and C27-bile | | | | | |
| | | acyl-CoAs to their (S)- | | | | | |
| | | stereoisomers; Peroxisome. | | | | | |
| | | Mitochondrion | | | | | |
| Alpha-S1-casein | P47710 | Important role in the capacity of | Renal | + | 2.1 | 64.0% | C |
| | | milk to transport calcium | cancer | | | | |
| | | phosphate; Secretion | | | | | |
| 15- | P15428 | Inactivation of prostaglandins; | Bladder | − | 2.8 | 88.4% | PC |
| hydroxyprostaglandin | | Cytoplasm | cancer | | | | |
| dehydrogenase | | | | | | | |
| 14-3-3 protein | P62258 | Adapter protein implicated in the | Melanoma | − | 2.8 | 88.4% | NC |
| epsilon | | regulation of a large spectrum of | | | | | |
| | | both general and specialized | | | | | |
| | | signaling pathway. Binds to a | | | | | |
| | | large number of partners, usually | | | | | |
| | | by recognition of a phosphoserine | | | | | |
| | | or phosphothreonine motif; | | | | | |
| | | Cytoplasm | | | | | |
| Carcinoembryonic | P31997 | Carcinoembryonic antigen; Cell | Lung | + | 2.8 | 88.4% | PC |
| antigen- | | membrane; Lipid-anchor, GPI- | cancer | | | | |
| related cell | | anchor | | | | | |
| adhesion | | | | | | | |
| molecule 8 | | | | | | | |

The symbol + and − indicates the protein is predicted as blood-secreted and non-blood-secreted respectively.
The results are categorized in one of the four classes: C (consistent), in which literature-annotated blood secreted proteins are predicted correctly; PC (partially consistent), in which proteins with some evidence indicating as blood-secreted or not are predicted correctly; NC (not consistent), in which the predicted result is not consistent with annotation.

TABLE 7
List of proteins encoded by differentially-expressed genes (both
up-regulated and down-regulated genes in cancer cells in comparison
with normal cells) and the status of SVM prediction.

| Gene | Protein | Protein | Prediction | | | Gene | Protein | Protein | Prediction | | |
|---|---|---|---|---|---|---|---|---|---|---|---|
| symbol | AC | name | R | P | class | symbol | AC | name | R | P | class |

Gastric cancer [35]

| | | | | | | | | | | | | |
|---|---|---|---|---|---|---|---|---|---|---|---|---|
| Up- | MATE1 | Q86VL8 | Multidrug | 3.2 | 96.1% | + | p30 | Q7Z7K6 | Proline-rich | 2.7 | 82.0% | + |
| regulated | | | and toxin | | | | | | protein 6 | | | |
| | | | extrusion | | | | | | | | | |
| | | | protein 2 | | | | | | | | | |
| | CKS1B | P61024 | Cyclin- | 2.1 | 64.0% | − | GPI | P06744 | Glucose-6- | 2.8 | 88.4% | + |
| | | | dependent | | | | | | phosphate | | | |
| | | | kinases | | | | | | isomerase | | | |
| | | | regulatory | | | | | | | | | |
| | | | subunit 1 | | | | | | | | | |
| | SCX | Q7RTU7 | Basic helix- | 2.8 | 88.4% | − | PRO2000 | Q6PL18 | ATPase family | 2.8 | 88.4% | + |
| | (SCXA) | | loop-helix | | | | | | AAA domain- | | | |
| | | | transcription | | | | | | containing | | | |
| | | | factor | | | | | | protein 2 | | | |
| | | | scleraxis | | | | | | | | | |
| | D1S155E | O75534 | Cold shock | 2.8 | 88.4% | + | CDC20 | Q12834 | Cell division | 2.8 | 88.4% | − |
| | | | domain- | | | | | | cycle | | | |
| | | | containing | | | | | | protein 20 | | | |
| | | | protein E1 | | | | | | homolog | | | |
| | FKBP4 | Q02790 | FK506- | 2.8 | 88.4% | − | FEN1 | P39748 | Flap | 2.8 | 88.4% | − |
| | | | binding | | | | | | endonuclease 1 | | | |
| | | | protein 4 | | | | | | | | | |
| | SKB1 | O14744 | Protein | 2.8 | 88.4% | − | ZNF9 | P62633 | Cellular | 2.8 | 88.4% | + |
| | | | arginine | | | | | | nucleic acid- | | | |
| | | | N-methyltrans- | | | | | | binding | | | |
| | | | ferase 5 | | | | | | protein | | | |
| | NT5C3 | Q9H0P0 | Cytosolic 5′- | 2.8 | 88.4% | + | RPS16 | P62249 | 40S | 2.8 | 88.4% | + |
| | | | nucleotidase 3 | | | | | | ribosomal | | | |
| | | | | | | | | | protein S16 | | | |
| Down- | LGALS1 | P09382 | Galectin-1 | 2.8 | 88.4% | − | MT2A | P02795 | Metallo- | 2.7 | 82.0% | − |
| regulated | | | | | | | | | thionein-2 | | | |
| | OAZ1 | P54368 | Ornithine | 2.8 | 88.4% | − | MAGED2 | Q9UNF1 | Melanoma- | 2.8 | 88.4% | − |
| | | | decarboxylase | | | | | | associated | | | |
| | | | antizyme | | | | | | antigen D2 | | | |
| | PEA15 | Q15121 | Astrocytic | 2.8 | 88.4% | − | NPDC1 | Q9NQX5 | Neural | 2.8 | 88.4% | + |
| | | | phosphoprotein | | | | | | proliferation | | | |
| | | | PEA-15 | | | | | | differentiation | | | |
| | | | | | | | | | and control | | | |
| | | | | | | | | | protein 1 | | | |
| | DXS9879E | Q14657 | L antigen | 2.7 | 82.0% | − | CXX1 | O15255 | CAAX box | 2.8 | 88.4% | + |
| | | | family | | | | | | protein 1 | | | |
| | | | member 3 | | | | | | | | | |
| | SEC61A1 | P61619 | Protein | 2.8 | 88.4% | + | FKBP8 | Q14318 | FK506- | 2.8 | 88.4% | − |
| | | | transport | | | | | | binding | | | |
| | | | protein Sec61 | | | | | | protein 8 | | | |
| | | | subunit alpha | | | | | | | | | |
| | | | isoform 1 | | | | | | | | | |
| | LGP1 | Q8N2G8 | GH3 | 2.9 | 90.3% | + | PGR1 | Q6NV75 | Probable | 2.8 | 88.4% | − |
| | | | domain- | | | | | | G-protein | | | |
| | | | containing | | | | | | coupled | | | |
| | | | protein | | | | | | receptor 153 | | | |

Squamous cell lung carcinoma [36]

| | | | | | | | | | | | | |
|---|---|---|---|---|---|---|---|---|---|---|---|---|
| Up- | PSMD11 | O00231 | 26S proteasome | 2.8 | 88.4% | + | CSNK2A1 | P68400 | Casein | 2.8 | 88.4% | − |
| regulated | | | non-ATPase | | | | | | kinase II | | | |
| | | | regulatory | | | | | | subunit | | | |
| | | | subunit 11 | | | | | | alpha | | | |
| | ADRM1 | Q16186 | Protein | 2.8 | 88.4% | − | PSMB4 | P28070 | Proteasome | 2.8 | 88.4% | + |
| | | | ADRM1 | | | | | | subunit | | | |
| | | | | | | | | | beta type-4 | | | |
| | DHCR7 | Q9UBM7 | 7-dehydro- | 2.8 | 88.4% | + | SAR1A | Q9NR31 | GTP-binding | 2.8 | 88.4% | − |
| | | | cholesterol | | | | | | protein | | | |
| | | | reductase | | | | | | SAR1a | | | |
| | HNRPA3 | P51991 | Heterogeneous | 2.7 | 82.0% | − | GARS | P41250 | Glycyl- | 2.8 | 88.4% | + |
| | | | nuclear | | | | | | tRNA | | | |
| | | | ribonucleo- | | | | | | synthetase | | | |
| | | | protein A3 | | | | | | | | | |
| | DNAJC9 | Q8WXX5 | DnaJ homolog | 2.3 | 70.3% | + | | | | | | |
| | | | subfamily | | | | | | | | | |
| | | | C member 9 | | | | | | | | | |
| Down- | HSD17B6 | O14756 | Hydroxysteroid | 2.8 | 88.4% | − | TNXA | Q62772 | Tenascin-X | 2.9 | 90.3% | − |
| regulated | | | 17-beta | | | | | | | | | |
| | | | dehydrogenase 6 | | | | | | | | | |
| | ABCA8 | O94911 | ATP-binding | 2.8 | 88.4% | − | C9orf61 | Q15884 | Uncharacterized | 2.8 | 88.4% | + |
| | | | cassette | | | | | | protein | | | |
| | | | sub-family | | | | | | C9orf61 | | | |
| | | | A member 8 | | | | | | | | | |
| | CFD | P00746 | Complement | 2.8 | 88.4% | + | CAT | P04040 | Catalase | 2.8 | 88.4% | + |
| | | | factor D | | | | | | | | | |
| | P2RY14 | Q15391 | P2Y | 2.8 | 88.4% | + | C7orf23 | Q9BU79 | Uncharacterized | 2.8 | 88.4% | + |
| | | | purinoceptor 14 | | | | | | protein | | | |
| | | | | | | | | | C7orf23 | | | |
| | GJA4 | P35212 | Gap junction | 2.7 | 82.0% | + | ECM2 | O94769 | Extracellular | 2.8 | 88.4% | + |
| | | | alpha-4 | | | | | | matrix | | | |
| | | | protein | | | | | | protein 2 | | | |
| | FAM107A | O95990 | Protein | 2.8 | 88.4% | − | KDR | P35968 | Vascular | 2.8 | 88.4% | + |
| | | | FAM107A | | | | | | endothelial | | | |
| | | | | | | | | | growth factor | | | |
| | | | | | | | | | receptor 2 | | | |
| | KIAA0672 | Q17R89 | Rho | 2.7 | 82.0% | − | ST3GAL5 | Q9UNP4 | Lactosylceramide | 2.8 | 88.4% | + |
| | | | GTPase- | | | | | | alpha-2,3- | | | |
| | | | activating | | | | | | sialyltransferase | | | |
| | | | protein | | | | | | | | | |
| | | | RICH2 | | | | | | | | | |
| | CLIC5 | Q9NZA1 | Chloride | 2.8 | 88.4% | + | ITM2A | O43736 | Integral | 2.2 | 68.0% | − |
| | | | intracellular | | | | | | membrane | | | |
| | | | channel | | | | | | protein 2A | | | |
| | | | protein 5 | | | | | | | | | |
| | ADH1B | P07327 | Alcohol | 2.8 | 88.4% | + | SLCO2A1 | Q92959 | Solute carrier | 2.8 | 88.4% | + |
| | | | dehydrogenase 1A | | | | | | organic anion | | | |
| | | | | | | | | | transporter | | | |
| | | | | | | | | | family member 2A1 | | | |
| | FOLR1 | P15328 | Folate | 2.8 | 88.4% | + | SCARF1 | Q14162 | Endothelial | 2.8 | 88.4% | + |
| | | | receptor | | | | | | cells | | | |
| | | | alpha | | | | | | scavenger | | | |
| | DAPK1 | P53355 | Death- | 2.8 | 88.4% | + | ASAH1 | Q13510 | Acid | 2.8 | 88.4% | − |
| | | | associated | | | | | | ceramidase | | | |
| | | | protein | | | | | | | | | |
| | CDH5 | P33151 | Cadherin-5 | 2.8 | 88.4% | + | ADCY9 | O60503 | Adenylate | 2.8 | 88.4% | + |
| | | | | | | | | | cyclase | | | |
| | | | | | | | | | type 9 | | | |
| | TEK | Q02763 | Angiopoietin-1 | 2.8 | 88.4% | + | FHL1 | Q13642 | Four and a | 2.1 | 64.0% | − |
| | | | receptor | | | | | | half LIM | | | |
| | | | | | | | | | domains | | | |
| | | | | | | | | | protein 1 | | | |
| | GNG11 | P61952 | Guanine | 2.7 | 82.0% | − | LMO3 | Q96BJ8 | Engulfment | 2.9 | 90.3% | − |
| | | | nucleotide- | | | | | | and cell | | | |
| | | | binding protein | | | | | | motility | | | |
| | | | G(I)/G(S)/G(O) | | | | | | protein 3 | | | |
| | | | subunit | | | | | | | | | |
| | | | gamma-11 | | | | | | | | | |
| | ERG | P11308 | Transcriptional | 2.8 | 88.4% | − | FOSB | P53539 | Protein | 2.8 | 88.4% | − |
| | | | regulator ERG | | | | | | fosB | | | |
| | LDB2 | O43679 | LIM | 2.8 | 88.4% | − | GADD45B | O75293 | Growth arrest | 2.8 | 88.4% | − |
| | | | domain- | | | | | | and DNA damage- | | | |
| | | | binding | | | | | | inducible | | | |
| | | | protein 2 | | | | | | protein | | | |
| | | | | | | | | | GADD45 beta | | | |
| | RNASE4 | P34096 | Ribonuclease 4 | 2.8 | 88.4% | + | TITF1 | P43699 | Homeobox protein | 2.8 | 88.4% | − |
| | | | | | | | | | Nkx-2.1 | | | |
| | KIAA1462 | Q9P266 | Uncharacterized | 4.3 | 100% | − | FOS | P01100 | Proto-oncogene | 2.8 | 88.4% | − |
| | | | protein | | | | | | protein c-fos | | | |
| | | | KIAA1462 | | | | | | | | | |
| | TAL1 | P17542 | T-cell acute | 2.8 | 88.4% | + | CD1C | P29017 | T-cell surface | 2.8 | 88.4% | + |
| | | | lymphocytic | | | | | | glycoprotein CD1c | | | |
| | | | leukemia | | | | | | | | | |
| | | | protein 1 | | | | | | | | | |
| | LRRC48 | Q9H069 | Leucine- | 2.1 | 64.0% | − | NR4A2 | P43354 | Nuclear receptor | 2.8 | 88.4% | − |
| | | | rich repeat- | | | | | | subfamily 4 | | | |
| | | | containing | | | | | | group A member 2 | | | |
| | | | protein 48 | | | | | | | | | |
| | HPN | P05981 | Serine | 2.8 | 88.4% | + | CX3CR1 | P49238 | CX3C | 2.7 | 82.0% | − |
| | | | protease | | | | | | chemokine | | | |
| | | | hepsin | | | | | | receptor 1 | | | |
| | DAPK2 | Q9UIK4 | Death- | 2.8 | 88.4% | − | ECM2 | O94769 | Extracellular | 2.8 | 88.4% | + |
| | | | associated | | | | | | matrix | | | |
| | | | protein | | | | | | protein 2 | | | |
| | | | kinase 2 | | | | | | | | | |
| | CHRDL1 | Q9BU40 | Chordin- | 2.8 | 88.4% | + | AOC3 | Q16853 | Membrane copper | 2.8 | 88.4% | + |
| | | | like protein 1 | | | | | | amine oxidase | | | |
| | LRRN3 | Q9H3W5 | Leucine- | 2.7 | 82.0% | − | ANGPT1 | Q15389 | Angiopoietin-1 | 2.8 | 88.4% | + |
| | | | rich repeat | | | | | | | | | |
| | | | neuronal | | | | | | | | | |
| | | | protein 3 | | | | | | | | | |

The symbol + and − indicates the protein is predicted as blood-secreted and non-blood-secreted, respectively (R: R-value, P: P-value).

### Exemplary Implementation of Protein Analysis Method for Urine

The following section describes an implementation of method 100 adapted to the analysis of urine. For brevity, only the embodiment-specific differences, as compared to the description above, are described below.

As urine is formed by filtration from blood through the kidneys, some proteins in blood pass through the kidney and can be excreted into urine. As a result, urinary proteins not only reflect the conditions of the kidney and the urogenital tract but also those of the other organs that are distant from the kidney (Barratt and Topham, 2007). Method 100 described above was applied to urine in order to train a classifier to predict which proteins in diseased tissue can be excreted into urine. Applying method 100 to urine enables correlation of proteins detected to have abnormal expressions in diseased tissues with potential protein/peptide markers in urine, which can be checked using various types of proteomic techniques on urine samples.

As with the implementation discussed above, the implementation for urine analysis begins with steps 103 and 105.

In step 103, a set of proteins found in urine samples is collected as the positive, secreted set. In an implementation of method 100, a set of 1,500 proteins identified in urine samples was used. These 1,500 proteins are discussed in Adachi et al. (2006). In an embodiment, step 103 comprises including urinary proteins that have been experimentally validated in major urinary proteome studies in the positive set.

Using the proteins found in previous urine proteomics studies as the positive set, an SVM-based classifier was used to separate the positive dataset from the negative dataset by using feature values associated with protein characteristics.

In step 105, another set of proteins is collected for the negative set. The representative negative set collected in step 105 comprises proteins that are believed to not be secreted into urine. In an embodiment, step 105 collects protein lists generated from Pfam families that the positive training data set proteins do not belong to. As a result, 2,627 and 2,148 proteins were generated for the training and the testing set, respectively.

As discussed above, step 109 is then performed to map the protein features of the urinary proteins that can well distinguish the positive samples from the negative sets selected in steps 103 and 105, respectively. In an embodiment, general knowledge about how proteins are excreted from blood into urine provides useful guidance in the feature mapping performed in step 109. In an embodiment, 1,313 proteins from the Swiss-Prot database having an accession ID are used to perform step 109. In another embodiment, data from 3 urinary proteome studies (Pieper et al., 2004; Castagna et al., 2005; Wang et al., 2006) are used in step 109 to obtain 460 non-overlapping proteins (i.e., proteins that are in the positive set or negative set, but not both sets).

In one embodiment, step 109 involves retrieving features from the Swiss-Prot database. In one implementation of method 100, 243 feature values representing 18 features were collected in this step. In this implementation, while the 243 feature values representing the 18 features differ from the features found for blood, the urine-related features were locally calculated and predicted using external tools and resources similar to those listed in Table 1 above. The 243 feature values are listed in Table 8 below. As described above, step 109 comprises performing a calculation on each feature value to determine its ranking. The protein features ranked for urinary proteins are listed in Table 11 below.

TABLE 8
243 Protein Feature Values for Urine-related Features

| Vector_index | FILE | DESCRIPTION | Group # | Details |
|---|---|---|---|---|
| 1 | SSCP-1 | alpha-content-method 2 | 1 | % of alpha-content |
| 2 | SSCP-2 | beta-content-method 2 | 1 | % of beta-content |
| 3 | SSCP-3 | coil-content-method 2 | 1 | % of coil-content |
| 4 | SSCP-4 | class-alpha (0), beta (1), | 1 | classes |
| | | mixed (2), irregular (3) | | |
| 5 | phobius-1 | transmembrane domain | 2 | number of TD |
| 6 | phobius-2 | singal peptide | 2 | presence of SP |
| 7 | Fldbin-1 | Number of residues | 3 | |
| | | (size) | | |
| 8 | Fldbin-2 | unfoldability | 3 | |
| 9 | Fldbin-3 | charge | 3 | |
| 10 | Fldbin-4 | phobicity | 3 | |
| 11 | Fldbin-5 | # of disordered regions | 3 | |
| 12 | Fldbin-6 | longest disordered | 3 | |
| | | regions | | |
| 13 | Fldbin-7 | # of disordered residues | 3 | |
| 14 | TatP-1 | Twin-arginine signal | 4 | present/absent |
| | | peptide motif | | |
| 15 | TMB-1 | BBTM protein score | 5 | analyzation of potential |
| | | | | transmembrane barrel |
| | | | | proteins using sequence |
| 16 | TMB-2 | logP BBTM/non-BBTM | 5 | |
| | | protein ratio | | |
| 17 | Profeat-1 | feature[F1.1.1.1] | 6 | Amino acid composition A |
| 18 | Profeat-2 | feature[F1.1.1.2] | 6 | Amino acid composition C |
| 19 | Profeat-3 | feature[F1.1.1.3] | 6 | Amino acid composition D |
| 20 | Profeat-4 | feature[F1.1.1.4] | 6 | Amino acid composition E |
| 21 | Profeat-5 | feature[F1.1.1.5] | 6 | Amino acid composition F |
| 22 | Profeat-6 | feature[F1.1.1.6] | 6 | Amino acid composition G |
| 23 | Profeat-7 | feature[F1.1.1.7] | 6 | Amino acid composition H |
| 24 | Profeat-8 | feature[F1.1.1.8] | 6 | Amino acid composition I |
| 25 | Profeat-9 | feature[F1.1.1.9] | 6 | Amino acid composition K |
| 26 | Profeat-10 | feature[F1.1.1.10] | 6 | Amino acid composition L |
| 27 | Profeat-11 | feature[F1.1.1.11] | 6 | Amino acid composition M |
| 28 | Profeat-12 | feature[F1.1.1.12] | 6 | Amino acid composition N |
| 29 | Profeat-13 | feature[F1.1.1.13] | 6 | Amino acid composition P |
| 30 | Profeat-14 | feature[F1.1.1.14] | 6 | Amino acid composition Q |
| 31 | Profeat-15 | feature[F1.1.1.15] | 6 | Amino acid composition R |
| 32 | Profeat-16 | feature[F1.1.1.16] | 6 | Amino acid composition S |
| 33 | Profeat-17 | feature[F1.1.1.17] | 6 | Amino acid composition T |
| 34 | Profeat-18 | feature[F1.1.1.18] | 6 | Amino acid composition V |
| 35 | Profeat-19 | feature[F1.1.1.19] | 6 | Amino acid composition W |
| 36 | Profeat-20 | feature[F1.1.1.20] | 6 | Amino acid composition Y |
| 37 | profeat_1141 | feature[F5.1.1.1] | 7 | Composition |
| | | | | Hydrophobicity-polar |
| | | | | (RKEDQN) |
| 38 | profeat_1142 | feature[F5.1.1.2] | 7 | Composition |
| | | | | Hydrophobicity-neutral |
| | | | | (GASTPHY) |
| 39 | profeat_1143 | feature[F5.1.1.3] | 7 | Composition |
| | | | | Hydrophobicity- |
| | | | | hydrophobic (CLVIMFW) |
| 40 | profeat_1144 | feature[F5.1.2.1] | 7 | Composition Normalized |
| | | | | van der Waals vol. (range |
| | | | | 0-2.78) |
| 41 | profeat_1145 | feature[F5.1.2.2] | 7 | Composition Normalized |
| | | | | van der Waals vol. (range |
| | | | | 2.95-4.0) |
| 42 | profeat_1146 | feature[F5.1.2.3] | 7 | Composition Normalized |
| | | | | van der Waals vol. (range |
| | | | | 4.03-8.08) |
| 43 | profeat_1147 | feature[F5.1.3.1] | 7 | Composition Polarity. |
| | | | | Polarity Value (4.9-6.2) |
| | | | | LIFWCMVY |
| 44 | profeat_1148 | feature[F5.1.3.2] | 7 | Composition Polarity. |
| | | | | Polarity Value (8.0-9.2) |
| | | | | PATGS |
| 45 | profeat_1149 | feature[F5.1.3.3] | 7 | Composition Polarity. |
| | | | | Polarity Value (10.4-13.0) |
| | | | | HQRKNED |
| 46 | profeat_1150 | feature[F5.1.4.1] | 7 | Composition Polarizability |
| | | | | value (0-1.08) GASDT |
| 47 | profeat_1151 | feature[F5.1.4.2] | 7 | Composition Polarizability |
| | | | | value (.128-.186) |
| | | | | CPNVEQIL |
| 48 | profeat_1152 | feature[F5.1.4.3] | 7 | Composition Polarizability |
| | | | | value (.219-.409) |
| | | | | KMHFRYW |
| 49 | profeat_1153 | feature[F5.1.5.1] | 7 | Composition Charge. |
| | | | | Positive (KR) |
| 50 | profeat_1154 | feature[F5.1.5.2] | 7 | Composition Charge. |
| | | | | Neutral |
| | | | | (ANCQGHILMFPSTWY |
| | | | | V) |
| 51 | profeat_1155 | feature[F5.1.5.3] | 7 | Composition Charge. |
| | | | | Negative (DE) |
| 52 | profeat_1156 | feature[F5.1.6.1] | 7 | Composition Secondary |
| | | | | Structure: Helix |
| | | | | (EALMQKRH) |
| 53 | profeat_1157 | feature[F5.1.6.2] | 7 | Composition secondary |
| | | | | Structure: Strand |
| | | | | (VIYCWFT) |
| 54 | profeat_1158 | feature[F5.1.6.3] | 7 | Composition Secondary |
| | | | | Structure: Coil (GNPSD) |
| 55 | profeat_1159 | feature[F5.1.7.1] | 7 | Composition Solvent |
| | | | | Accessibility: Buried |
| | | | | (ALFCGIVW) |
| 56 | profeat_1160 | feature[F5.1.7.2] | 7 | Composition Solvent |
| | | | | Accessibility: |
| | | | | Exposed (RKQEND) |
| 57 | profeat_1161 | feature[F5.1.7.3] | 7 | Composition Solvent |
| | | | | Accessibility: Intermediate |
| | | | | (MPSTHY) |
| 58 | profeat_1162 | feature[F5.2.1.1] | 8 | Transition Hydrophobicity- |
| | | | | polar (RKEDQN) |
| 59 | profeat_1163 | feature[F5.2.1.2] | 8 | Transition Hydrophobicity- |
| | | | | neutral (GASTPHY) |
| 60 | profeat_1164 | feature[F5.2.1.3] | 8 | Transition Hydrophobicity- |
| | | | | hydrophobic (CLVIMFW) |
| 61 | profeat_1165 | feature[F5.2.2.1] | 8 | Transition Normalized van |
| | | | | der Waals vol. (range 0-2.78) |
| 45 | profeat_1149 | feature[F5.1.3.3] | 7 | Composition Polarity. |
| | | | | Polarity Value (10.4-13.0) |
| | | | | HQRKNED |
| 46 | profeat_1150 | feature[F5.1.4.1] | 7 | Composition Polarizability |
| | | | | value (0-1.08) GASDT |
| 47 | profeat_1151 | feature[F5.1.4.2] | 7 | Composition Polarizability |
| | | | | value (.128-.186) |
| | | | | CPNVEQIL |
| 48 | profeat_1152 | feature[F5.1.4.3] | 7 | Composition Polarizability |
| | | | | value (.219-.409) |
| | | | | KMHFRYW |
| 49 | profeat_1153 | feature[F5.1.5.1] | 7 | Composition Charge. |
| | | | | Positive (KR) |
| 50 | profeat_1154 | feature[F5.1.5.2] | 7 | Composition Charge. |
| | | | | Neutral |
| | | | | (ANCQGHILMFPSTWY |
| | | | | V) |
| 51 | profeat_1155 | feature[F5.1.5.3] | 7 | Composition Charge. |
| | | | | Negative (DE) |
| 52 | profeat_1156 | feature[F5.1.6.1] | 7 | Composition Secondary |
| | | | | Structure: Helix |
| | | | | (EALMQKRH) |
| 53 | profeat_1157 | feature[F5.1.6.2] | 7 | Composition secondary |
| | | | | Structure: Strand |
| | | | | (VIYCWFT) |
| 54 | profeat_1158 | feature[F5.1.6.3] | 7 | Composition Secondary |
| | | | | Structure: Coil (GNPSD) |
| 55 | profeat_1159 | feature[F5.1.7.1] | 7 | Composition Solvent |
| | | | | Accessibility: Buried |
| | | | | (ALFCGIVW) |
| 56 | profeat_1160 | feature[F5.1.7.2] | 7 | Composition Solvent |
| | | | | Accessibility: |
| | | | | Exposed (RKQEND) |
| 57 | profeat_1161 | feature[F5.1.7.3] | 7 | Composition Solvent |
| | | | | Accessibility: Intermediate |
| | | | | (MPSTHY) |
| 58 | profeat_1162 | feature[F5.2.1.1] | 8 | Transition Hydrophobicity- |
| | | | | polar (RKEDQN) |
| 59 | profeat_1163 | feature[F5.2.1.2] | 8 | Transition Hydrophobicity- |
| | | | | neutral (GASTPHY) |
| 60 | profeat_1164 | feature[F5.2.1.3] | 8 | Transition Hydrophobicity- |
| | | | | hydrophobic (CLVIMFW) |
| 61 | profeat_1165 | feature[F5.2.2.1] | 8 | Transition Normalized van |
| | | | | der Waals vol. (range 0-2.78) |
| 62 | profeat_1166 | feature[F5.2.2.2] | 8 | Transition Normalized van |
| | | | | der Waals vol. (range 2.95-4.0) |
| 63 | profeat_1167 | feature[F5.2.2.3] | 8 | Transition Normalized van |
| | | | | der Waals vol. (range 4.03-8.08) |
| 64 | profeat_1168 | feature[F5.2.3.1] | 8 | Transition Polarity. |
| | | | | Polarity Value (4.9-6.2) |
| | | | | LIFWCMVY |
| 65 | profeat_1169 | feature[F5.2.3.2] | 8 | Transition Polarity. |
| | | | | Polarity Value (8.0-9.2) |
| | | | | PATGS |
| 66 | profeat_1170 | feature[F5.2.3.3] | 8 | Transition Polarity. |
| | | | | Polarity Value (10.4-13.0) |
| | | | | HQRKNED |
| 67 | profeat_1171 | feature[F5.2.4.1] | 8 | Transition Polarizability |
| | | | | value (0-1.08) GASDT |
| 68 | profeat_1172 | feature[F5.2.4.2] | 8 | Transition Polarizability |
| | | | | value (.128-.186) |
| | | | | CPNVEQIL |
| 69 | profeat_1173 | feature[F5.2.4.3] | 8 | Transition Polarizability |
| | | | | value (.219-.409) |
| | | | | KMHFRYW |
| 70 | profeat_1174 | feature[F5.2.5.1] | 8 | Transition Charge. Positive |
| | | | | (KR) |
| 71 | profeat_1175 | feature[F5.2.5.2] | 8 | Transition Charge. Neutral |
| | | | | (ANCQGHILMFPSTWY |
| | | | | V) |
| 72 | profeat_1176 | feature[F5.2.5.3] | 8 | Transition Charge. |
| | | | | Negative (DE) |
| 73 | profeat_1177 | feature[F5.2.6.1] | 8 | Transition Secondary |
| | | | | Structure: Helix |
| | | | | (EALMQKRH) |
| 74 | profeat_1178 | feature[F5.2.6.2] | 8 | Transition secondary |
| | | | | Structure: Strand |
| | | | | (VIYCWFT) |
| 75 | profeat_1179 | feature[F5.2.6.3] | 8 | Transition Secondary |
| | | | | Structure: Coil (GNPSD) |
| 76 | profeat_1180 | feature[F5.2.7.1] | 8 | Transition Solvent |
| | | | | Accessibility: Buried |
| | | | | (ALFCGIVW) |
| 77 | profeat_1181 | feature[F5.2.7.2] | 8 | Transition Solvent |
| | | | | Accessibility: |
| | | | | Exposed (RKQEND) |
| 78 | profeat_1182 | feature[F5.2.7.3] | 8 | Transition Solvent |
| | | | | Accessibility: Intermediate |
| | | | | (MPSTHY) |
| 79 | profeat_1183 | feature[F5.3.1.1] | 9 | Distribution |
| 80 | profeat_1184 | feature[F5.3.1.2] | 9 | Distribution |
| 81 | profeat_1185 | feature[F5.3.1.3] | 9 | Distribution |
| 82 | profeat_1186 | feature[F5.3.1.4] | 9 | Distribution |
| 83 | profeat_1187 | feature[F5.3.1.5] | 9 | Distribution |
| 84 | profeat_1188 | feature[F5.3.1.6] | 9 | Distribution |
| 85 | profeat_1189 | feature[F5.3.1.7] | 9 | Distribution |
| 86 | profeat_1190 | feature[F5.3.1.8] | 9 | Distribution |
| 87 | profeat_1191 | feature[F5.3.1.9] | 9 | Distribution |
| 88 | profeat_1192 | feature[F5.3.1.10] | 9 | Distribution |
| 89 | profeat_1193 | feature[F5.3.1.11] | 9 | Distribution |
| 90 | profeat_1194 | feature[F5.3.1.12] | 9 | Distribution |
| 91 | profeat_1195 | feature[F5.3.1.13] | 9 | Distribution |
| 92 | profeat_1196 | feature[F5.3.1.14] | 9 | Distribution |
| 93 | profeat_1197 | feature[F5.3.1.15] | 9 | Distribution |
| 94 | profeat_1198 | feature[F5.3.2.1] | 9 | Distribution |
| 95 | profeat_1199 | feature[F5.3.2.2] | 9 | Distribution |
| 96 | profeat_1200 | feature[F5.3.2.3] | 9 | Distribution |
| 97 | profeat_1201 | feature[F5.3.2.4] | 9 | Distribution |
| 98 | profeat_1202 | feature[F5.3.2.5] | 9 | Distribution |
| 99 | profeat_1203 | feature[F5.3.2.6] | 9 | Distribution |
| 100 | profeat_1204 | feature[F5.3.2.7] | 9 | Distribution |
| 101 | profeat_1205 | feature[F5.3.2.8] | 9 | Distribution |
| 102 | profeat_1206 | feature[F5.3.2.9] | 9 | Distribution |
| 103 | profeat_1207 | feature[F5.3.2.10] | 9 | Distribution |
| 104 | profeat_1208 | feature[F5.3.2.11] | 9 | Distribution |
| 105 | profeat_1209 | feature[F5.3.2.12] | 9 | Distribution |
| 106 | profeat_1210 | feature[F5.3.2.13] | 9 | Distribution |
| 107 | profeat_1211 | feature[F5.3.2.14] | 9 | Distribution |
| 108 | profeat_1212 | feature[F5.3.2.15] | 9 | Distribution |
| 109 | profeat_1213 | feature[F5.3.3.1] | 9 | Distribution |
| 110 | profeat_1214 | feature[F5.3.3.2] | 9 | Distribution |
| 111 | profeat_1215 | feature[F5.3.3.3] | 9 | Distribution |
| 112 | profeat_1216 | feature[F5.3.3.4] | 9 | Distribution |
| 113 | profeat_1217 | feature[F5.3.3.5] | 9 | Distribution |
| 114 | profeat_1218 | feature[F5.3.3.6] | 9 | Distribution |
| 115 | profeat_1219 | feature[F5.3.3.7] | 9 | Distribution |
| 116 | profeat_1220 | feature[F5.3.3.8] | 9 | Distribution |
| 117 | profeat_1221 | feature[F5.3.3.9] | 9 | Distribution |
| 118 | profeat_1222 | feature[F5.3.3.10] | 9 | Distribution |
| 119 | profeat_1223 | feature[F5.3.3.11] | 9 | Distribution |
| 120 | profeat_1224 | feature[F5.3.3.12] | 9 | Distribution |
| 121 | profeat_1225 | feature[F5.3.3.13] | 9 | Distribution |
| 122 | profeat_1226 | feature[F5.3.3.14] | 9 | Distribution |
| 123 | profeat_1227 | feature[F5.3.3.15] | 9 | Distribution |
| 124 | profeat_1228 | feature[F5.3.4.1] | 9 | Distribution |
| 125 | profeat_1229 | feature[F5.3.4.2] | 9 | Distribution |
| 126 | profeat_1230 | feature[F5.3.4.3] | 9 | Distribution |
| 127 | profeat_1231 | feature[F5.3.4.4] | 9 | Distribution |
| 128 | profeat_1232 | feature[F5.3.4.5] | 9 | Distribution |
| 129 | profeat_1233 | feature[F5.3.4.6] | 9 | Distribution |
| 130 | profeat_1234 | feature[F5.3.4.7] | 9 | Distribution |
| 131 | profeat_1235 | feature[F5.3.4.8] | 9 | Distribution |
| 132 | profeat_1236 | feature[F5.3.4.9] | 9 | Distribution |
| 133 | profeat_1237 | feature[F5.3.4.10] | 9 | Distribution |
| 134 | profeat_1238 | feature[F5.3.4.11] | 9 | Distribution |
| 135 | profeat_1239 | feature[F5.3.4.12] | 9 | Distribution |
| 136 | profeat_1240 | feature[F5.3.4.13] | 9 | Distribution |
| 137 | profeat_1241 | feature[F5.3.4.14] | 9 | Distribution |
| 138 | profeat_1242 | feature[F5.3.4.15] | 9 | Distribution |
| 139 | profeat_1243 | feature[F5.3.5.1] | 9 | Distribution |
| 140 | profeat_1244 | feature[F5.3.5.2] | 9 | Distribution |
| 141 | profeat_1245 | feature[F5.3.5.3] | 9 | Distribution |
| 142 | profeat_1246 | feature[F5.3.5.4] | 9 | Distribution |
| 143 | profeat_1247 | feature[F5.3.5.5] | 9 | Distribution |
| 144 | profeat_1248 | feature[F5.3.5.6] | 9 | Distribution |
| 145 | profeat_1249 | feature[F5.3.5.7] | 9 | Distribution |
| 146 | profeat_1250 | feature[F5.3.5.8] | 9 | Distribution |
| 147 | profeat_1251 | feature[F5.3.5.9] | 9 | Distribution |
| 148 | profeat_1252 | feature[F5.3.5.10] | 9 | Distribution |
| 149 | profeat_1253 | feature[F5.3.5.11] | 9 | Distribution |
| 150 | profeat_1254 | feature[F5.3.5.12] | 9 | Distribution |
| 151 | profeat_1255 | feature[F5.3.5.13] | 9 | Distribution |
| 152 | profeat_1256 | feature[F5.3.5.14] | 9 | Distribution |
| 153 | profeat_1257 | feature[F5.3.5.15] | 9 | Distribution |
| 154 | profeat_1258 | feature[F5.3.6.1] | 9 | Distribution |
| 155 | profeat_1259 | feature[F5.3.6.2] | 9 | Distribution |
| 156 | profeat_1260 | feature[F5.3.6.3] | 9 | Distribution |
| 157 | profeat_1261 | feature[F5.3.6.4] | 9 | Distribution |
| 158 | profeat_1262 | feature[F5.3.6.5] | 9 | Distribution |
| 159 | profeat_1263 | feature[F5.3.6.6] | 9 | Distribution |
| 160 | profeat_1264 | feature[F5.3.6.7] | 9 | Distribution |
| 161 | profeat_1265 | feature[F5.3.6.8] | 9 | Distribution |
| 162 | profeat_1266 | feature[F5.3.6.9] | 9 | Distribution |
| 163 | profeat_1267 | feature[F5.3.6.10] | 9 | Distribution |
| 164 | profeat_1268 | feature[F5.3.6.11] | 9 | Distribution |
| 165 | profeat_1269 | feature[F5.3.6.12] | 9 | Distribution |
| 166 | profeat_1270 | feature[F5.3.6.13] | 9 | Distribution |
| 167 | profeat_1271 | feature[F5.3.6.14] | 9 | Distribution |
| 168 | profeat_1272 | feature[F5.3.6.15] | 9 | Distribution |
| 169 | profeat_1273 | feature[F5.3.7.1] | 9 | Distribution |
| 170 | profeat_1274 | feature[F5.3.7.2] | 9 | Distribution |
| 171 | profeat_1275 | feature[F5.3.7.3] | 9 | Distribution |
| 172 | profeat_1276 | feature[F5.3.7.4] | 9 | Distribution |
| 173 | profeat_1277 | feature[F5.3.7.5] | 9 | Distribution |
| 174 | profeat_1278 | feature[F5.3.7.6] | 9 | Distribution |
| 175 | profeat_1279 | feature[F5.3.7.7] | 9 | Distribution |
| 176 | profeat_1280 | feature[F5.3.7.8] | 9 | Distribution |
| 177 | profeat_1281 | feature[F5.3.7.9] | 9 | Distribution |
| 178 | profeat_1282 | feature[F5.3.7.10] | 9 | Distribution |
| 179 | profeat_1283 | feature[F5.3.7.11] | 9 | Distribution |
| 180 | profeat_1284 | feature[F5.3.7.12] | 9 | Distribution |
| 181 | profeat_1285 | feature[F5.3.7.13] | 9 | Distribution |
| 182 | profeat_1286 | feature[F5.3.7.14] | 9 | Distribution |
| 183 | profeat_1287 | feature[F5.3.7.15] | 9 | Distribution |
| 184 | profeat_1448 | feature[F7.1.1.1] | 10 | Pseudo-AA descriptors |
| 185 | profeat_1449 | feature[F7.1.1.2] | 10 | Pseudo-AA descriptors |
| 186 | profeat_1450 | feature[F7.1.1.3] | 10 | Pseudo-AA descriptors |
| 187 | profeat_1451 | feature[F7.1.1.4] | 10 | Pseudo-AA descriptors |
| 188 | profeat_1452 | feature[F7.1.1.5] | 10 | Pseudo-AA descriptors |
| 189 | profeat_1453 | feature[F7.1.1.6] | 10 | Pseudo-AA descriptors |
| 190 | profeat_1454 | feature[F7.1.1.7] | 10 | Pseudo-AA descriptors |
| 191 | profeat_1455 | feature[F7.1.1.8] | 10 | Pseudo-AA descriptors |
| 192 | profeat_1456 | feature[F7.1.1.9] | 10 | Pseudo-AA descriptors |
| 193 | profeat_1457 | feature[F7.1.1.10] | 10 | Pseudo-AA descriptors |
| 194 | profeat_1458 | feature[F7.1.1.11] | 10 | Pseudo-AA descriptors |
| 195 | profeat_1459 | feature[F7.1.1.12] | 10 | Pseudo-AA descriptors |
| 196 | profeat_1460 | feature[F7.1.1.13] | 10 | Pseudo-AA descriptors |
| 197 | profeat_1461 | feature[F7.1.1.14] | 10 | Pseudo-AA descriptors |
| 198 | profeat_1462 | feature[F7.1.1.15] | 10 | Pseudo-AA descriptors |
| 199 | profeat_1463 | feature[F7.1.1.16] | 10 | Pseudo-AA descriptors |
| 200 | profeat_1464 | feature[F7.1.1.17] | 10 | Pseudo-AA descriptors |
| 201 | profeat_1465 | feature[F7.1.1.18] | 10 | Pseudo-AA descriptors |
| 202 | profeat_1466 | feature[F7.1.1.19] | 10 | Pseudo-AA descriptors |
| 203 | profeat_1467 | feature[F7.1.1.20] | 10 | Pseudo-AA descriptors |
| 204 | profeat_1468 | feature[F7.1.1.21] | 10 | Pseudo-AA descriptors |
| 205 | profeat_1469 | feature[F7.1.1.22] | 10 | Pseudo-AA descriptors |
| 206 | profeat_1470 | feature[F7.1.1.23] | 10 | Pseudo-AA descriptors |
| 207 | profeat_1471 | feature[F7.1.1.24] | 10 | Pseudo-AA descriptors |
| 208 | profeat_1472 | feature[F7.1.1.25] | 10 | Pseudo-AA descriptors |
| 209 | profeat_1473 | feature[F7.1.1.26] | 10 | Pseudo-AA descriptors |
| 210 | profeat_1474 | feature[F7.1.1.27] | 10 | Pseudo-AA descriptors |
| 211 | profeat_1475 | feature[F7.1.1.28] | 10 | Pseudo-AA descriptors |
| 212 | profeat_1476 | feature[F7.1.1.29] | 10 | Pseudo-AA descriptors |
| 213 | profeat_1477 | feature[F7.1.1.30] | 10 | Pseudo-AA descriptors |
| 214 | profeat_1478 | feature[F7.1.1.31] | 10 | Pseudo-AA descriptors |
| 215 | profeat_1479 | feature[F7.1.1.32] | 10 | Pseudo-AA descriptors |
| 216 | profeat_1480 | feature[F7.1.1.33] | 10 | Pseudo-AA descriptors |
| 217 | profeat_1481 | feature[F7.1.1.34] | 10 | Pseudo-AA descriptors |
| 218 | profeat_1482 | feature[F7.1.1.35] | 10 | Pseudo-AA descriptors |
| 219 | profeat_1483 | feature[F7.1.1.36] | 10 | Pseudo-AA descriptors |
| 220 | profeat_1484 | feature[F7.1.1.37] | 10 | Pseudo-AA descriptors |
| 221 | profeat_1485 | feature[F7.1.1.38] | 10 | Pseudo-AA descriptors |
| 222 | profeat_1486 | feature[F7.1.1.39] | 10 | Pseudo-AA descriptors |
| 223 | profeat_1487 | feature[F7.1.1.40] | 10 | Pseudo-AA descriptors |
| 224 | profeat_1488 | feature[F7.1.1.41] | 10 | Pseudo-AA descriptors |
| 225 | profeat_1489 | feature[F7.1.1.42] | 10 | Pseudo-AA descriptors |
| 226 | profeat_1490 | feature[F7.1.1.43] | 10 | Pseudo-AA descriptors |
| 227 | profeat_1491 | feature[F7.1.1.44] | 10 | Pseudo-AA descriptors |
| 228 | profeat_1492 | feature[F7.1.1.45] | 10 | Pseudo-AA descriptors |
| 229 | profeat_1493 | feature[F7.1.1.46] | 10 | Pseudo-AA descriptors |
| 230 | profeat_1494 | feature[F7.1.1.47] | 10 | Pseudo-AA descriptors |
| 231 | profeat_1495 | feature[F7.1.1.48] | 10 | Pseudo-AA descriptors |
| 232 | profeat_1496 | feature[F7.1.1.49] | 10 | Pseudo-AA descriptors |
| 233 | profeat_1497 | feature[F7.1.1.50] | 10 | Pseudo-AA descriptors |
| 234 | netNGlyc | presence of N-Glyc site | 11 | presence N-glyc site |
| 235 | netNGlyc | Number of N-Glyc site | 11 | Number of N-glyc site |
| 236 | netOGlyc | presence of O-Glyc site | 12 | presence O-glyc site |
| 237 | netOGlyc | Number of O-Glyc site | 12 | Number of O-glyc site |
| 238 | Charge | Charge | 13 | calculated |
| 239 | Radius of | Radius of Gyration | 14 | Radius of Gyration |
| | Gyration | | | |
| 240 | Radius | Radius | 15 | Radius |
| 241 | PI | PI | 16 | Isoelectric point |
| 242 | MW | MW | 17 | Molecular weight |
| 243 | % of | # of disordered residue/# | 18 | % of disordered region |
| | disordered | of total residue | | |
| | region | | | |

In step 111, a classifier is trained to recognize classes of proteins secreted into urine, as generally described above. In one implementation, a Radial Basis Function (RBF) kernel SVM classifier can be used in step 111 to train the classifier to classify urinary proteins against non-urinary proteins. In an implementation, functional enrichment analysis with a database for annotation and visualization can be performed in this step for 480 predicted to be excreted proteins and functional annotation clustering analysis can be performed using human proteins. The overall enrichment score for the group was determined by enrichment scores from the EASE software application for each clustering. Mechanisms for doing these steps are described in Dennis et al. (2003) and Huang et al. (2009).

In one implementation, the most prominent feature of the excreted proteins used to train the classifier in step 111 was the presence of the signal peptide. As used herein, the signal peptide refers to any N-terminal amino acid on a protein that can later be cleaved. Other relevant features include secondary structure. Additionally, several feature values describing the secondary structure were relevant, as was the percentage of alpha content.

Step 111 can also include use of a KEGG Orthology (KO)-Based Annotation System in conjunction with a KO-Based Annotation System (KOBAS). Mechanisms for achieving this are described in Mao et al. (2005) and Wu et al. (2006). This approach enables the classifier to be trained by finding statistically enriched and underrepresented pathways for predicted to be excreted proteins. The KOBAS system takes in a set of sequences and annotates KEGG orthology terms based on BLAST similarity. The annotated KO terms can then be compared against all human proteins. The pathway is considered enriched or underrepresented if there are more than 2 fold changes of percentage composition. For urine, the charge of the protein is among the top ranked features of excreted proteins. Accordingly, the classifier can be trained to recognize the charge of a protein as a factor in determining which protein gets filtered through the glomerulus wall in the kidney and into urine. However, in one implementation, the molecular size found as an irrelevant feature for secretion of proteins into urine. This is because proteins in blood may already be in partial form before they are degraded even further. Further, a majority of proteins found in urine are heavily degraded (Osicka et al., 1997). While a whole protein may not be able to filter through, mainly due to its size or a shape, a fragment of a protein will not have a problem passing through the podocyte slits. As a result, the molecular size of the whole protein was found to be an insignificant factor in predicting the excretion status of a protein.

In one embodiment, 2 classifiers are trained in step 111, as shown in Table 9 below. Model 1 predicts has higher specificity and lower sensitivity, whereas, model 2 shows the balanced performance. Due to the unbalanced number of datasets, accuracy (denoted as ACC in Table 9) may not be the best measure to determine the performance of the model. Thus, as shown in Table 9, Matthew's Correlation Coefficient (MCC) is used as a measurement of quality of binary classification. As depicted in Table 9 below, the level of performance by these two classifiers is generally consistent, ranging from 85.7% to 94.9%.

TABLE 9
Performance statistics of two classifiers in the training and independent set

| | Model | | | | | Prediction Accuracy | | | |
|---|---|---|---|---|---|---|---|---|---|
| Dataset | Model | TP | TN | FP | FN | SE (%) | SP (%) | ACC | MCC |
| Training | 1 | 792 | 2493 | 134 | 341 | 74 | 94.9 | 0.8794 | 0.5228 |
| Training | 2 | 1164 | 2230 | 297 | 149 | 88.6 | 88.7 | 0.8868 | 0.5697 |
| Independent | 1 | 360 | 1983 | 165 | 100 | 78.3 | 92.3 | 0.8984 | 0.4500 |
| Independent | 2 | 404 | 1838 | 310 | 56 | 87.8 | 85.7 | 0.85966 | 0.39358 |

Control is then passed to step 112.

As discussed above, steps 112-114 are repeated until a manageable, reduced set of features, without losing the classification performance, is obtained, thereby producing a re-trained classifier in step 115. In an embodiment, a Radial Basis Function (RBF) kernel SVM classifier can be used to train the classifier to classify urinary proteins against non-urinary proteins. As shown in Table 10 below, in an implementation of method 100, the highest accuracy for predictions was achieved when 74 protein features were used to train an RBF kernel SVM classifier. These 74 protein features are listed in Table 11 below.

Table 10 lists the performance of classifiers (models developed in step 111) based on features selected in step 109. As listed in Table 10, the prediction accuracy for the urine implementation of the invention ranges from 80.4% to 81.29% when 53 to 77 protein features are used, with the highest accuracy of 81.29% achieved when using the 74 protein features listed in Table 11.

TABLE 10
Feature Selection. Prediction Accuracy Based on Selected Features with
Optimal Parameters

| Number of Features | Accuracy |
|---|---|
| 53 | 80.40610 |
| 56 | 80.50760 |
| 64 | 80.58380 |
| 66 | 80.71070 |
| 70 | 80.81220 |
| 74 | 81.29440 |
| 77 | 81.14210 |

TABLE 11
Features important for characterizing urine-secreted proteins

| Rank | Description |
|---|---|
| 1 | presence of Signal Pepetide |
| 2 | Composition Secondary Structure: Helix (EALMQKRH) |
| 3 | Composition Normalized van der Waals vol. (range 0-2.78) |
| 4 | % of alpha-content |
| 5 | Transition Normalized van der Waals vol. (range 4.03-8.08) |
| 6 | Transition Secondary Structure: Coil (GNPSD) |
| 7 | Transition Polarizability value (.219-.409) KMHFRYW |
| 8 | Composition Charge. Positive (KR) |
| 9 | Composition Polarizability value (0-1.08) GASDT |
| 10 | Transition Polarizability value (0-1.08) GASDT |
| 11 | Composition Normalized van der Waals vol. (range 4.03-8.08) |
| 12 | Composition Polarizability value (.219-.409) KMHFRYW |
| 13 | % of coil-content |
| 14 | Amino acid composition G |
| 15 | Pseudo-AA descriptors |
| 16 | Amino acid composition T |
| 17 | Composition Secondary Structure: Coil (GNPSD) |
| 18 | Isoelectric point |
| 19 | Composition Charge. Neutral (ANCQGHILMFPSTWYV) |
| 20 | Transition Charge. Positive (KR) |
| 21 | Composition Hydrophobicity-neutral (GASTPHY) |
| 22 | Transition Normalized van der Waals vol. (range 0-2.78) |
| 23 | Transition Solvent Accessibility: Exposed (RKQEND) |
| 24 | Composition Polarity. Polarity Value (8.0-9.2) PATGS |
| 25 | Composition Polarity. Polarity Value (10.4-13.0) HQRKNED |
| 26 | Distribution |
| 27 | Pseudo-AA descriptors |
| 28 | Pseudo-AA descriptors |
| 29 | Distribution |
| 30 | Amino acid composition R |
| 31 | Composition secondary Structure: Strand (VIYCWFT) |
| 32 | Number of N-glyc site |
| 33 | Composition Hydrophobicity-polar (RKEDQN) |
| 34 | Composition Solvent Accessibility: Exposed (RKQEND) |
| 35 | Transition Polarity. Polarity Value (4.9-6.2) LIFWCMVY |
| 36 | Pseudo-AA descriptors |
| 37 | % of disordered region |
| 38 | Amino acid composition K |
| 39 | Amino acid composition C |
| 40 | calculated |
| 41 | Distribution |
| 42 | Pseudo-AA descriptors |
| 43 | Pseudo-AA descriptors |
| 44 | Distribution |
| 45 | Amino acid composition M |
| 46 | Amino acid composition E |
| 47 | Pseudo-AA descriptors |
| 48 | Transition Charge. Neutral (ANCQGHILMFPSTWYV) |
| 49 | Distribution |
| 50 | Distribution |
| 51 | Transition Hydrophobicity-neutral (GASTPHY) |
| 52 | Transition Polarity. Polarity Value (8.0-9.2) PATGS |
| 53 | Composition Solvent Accessibility: Buried (ALFCGIVW) |
| 54 | Distribution |
| 55 | Pseudo-AA descriptors |
| 56 | Distribution |
| 57 | Composition Normalized van der Waals vol. (range 2.95-4.0) |
| 58 | Distribution |
| 59 | Transition Hydrophobicity-hydrophobic (CLVIMFW) |
| 60 | Charge |
| 61 | Pseudo-AA descriptors |
| 62 | Amino acid composition H |
| 63 | Unfoldability |
| 64 | Amino acid composition L |
| 65 | Distribution |
| 66 | Distribution |
| 67 | presence O-glyc site |
| 68 | Amino acid composition N |
| 69 | Distribution |
| 70 | Amino acid composition Y |
| 71 | Amino acid composition W |
| 72 | Pseudo-AA descriptors |
| 73 | Amino acid composition V |
| 74 | Pseudo-AA descriptors |
| 33 | Composition Hydrophobicity-polar (RKEDQN) |
| 34 | Composition Solvent Accessibility: Exposed (RKQEND) |
| 35 | Transition Polarity. Polarity Value (4.9-6.2) LIFWCMVY |
| 36 | Pseudo-AA descriptors |
| 37 | % of disordered region |
| 38 | Amino acid composition K |
| 39 | Amino acid composition C |
| 40 | calculated |
| 41 | Distribution |
| 42 | Pseudo-AA descriptors |
| 43 | Pseudo-AA descriptors |
| 44 | Distribution |
| 45 | Amino acid composition M |
| 46 | Amino acid composition E |
| 47 | Pseudo-AA descriptors |
| 48 | Transition Charge. Neutral (ANCQGHILMFPSTWYV) |
| 49 | Distribution |
| 50 | Distribution |
| 51 | Transition Hydrophobicity-neutral (GASTPHY) |
| 52 | Transition Polarity. Polarity Value (8.0-9.2) PATGS |
| 53 | Composition Solvent Accessibility: Buried (ALFCGIVW) |
| 54 | Distribution |
| 55 | Pseudo-AA descriptors |
| 56 | Distribution |
| 57 | Composition Normalized van der Waals vol. (range 2.95-4.0) |
| 58 | Distribution |
| 59 | Transition Hydrophobicity-hydrophobic (CLVIMFW) |
| 60 | Charge |
| 61 | Pseudo-AA descriptors |
| 62 | Amino acid composition H |
| 63 | Unfoldability |
| 64 | Amino acid composition L |
| 65 | Distribution |
| 66 | Distribution |
| 67 | presence O-glyc site |
| 68 | Amino acid composition N |
| 69 | Distribution |
| 70 | Amino acid composition Y |
| 71 | Amino acid composition W |
| 72 | Pseudo-AA descriptors |
| 73 | Amino acid composition V |
| 74 | Pseudo-AA descriptors |

As discussed above, one or more protein sequences are received in step 119 and after vector generation and scaling in step 120, the class of the one or more proteins is predicted in step 121. In one implementation, model 1 listed in Table 9 and described above was used to predict the proteins that can be excreted to urine on 2,048 proteins that showed expression level change between the gastric cancer patients and normal samples. In the implementation, the 2,048 proteins were selected by comparing 17,812 genes on an Affymetrix Human exon array 1.0 from tissue samples of gastric cancer patients and normal tissue samples. Among the 2,048 proteins, 480 were predicted, using the trained classifier, to be excreted into the urine. For the predicted excreted proteins, up to 11 proteins are above 98% confidence level. The chance for false positive rate at this confidence level is less than 0.02%, thus these proteins are highly likely to be excreted into urine. A total of 203 proteins out of 408 proteins have more than 92% confidence to be excreted to urine, with false positive rate of less than 0.7%. Proteins such as these predicted by the model in step 121 to be excreted into urine are candidates for further biomarker studies in urine.

Exemplary Protein Analysis with a User Interface

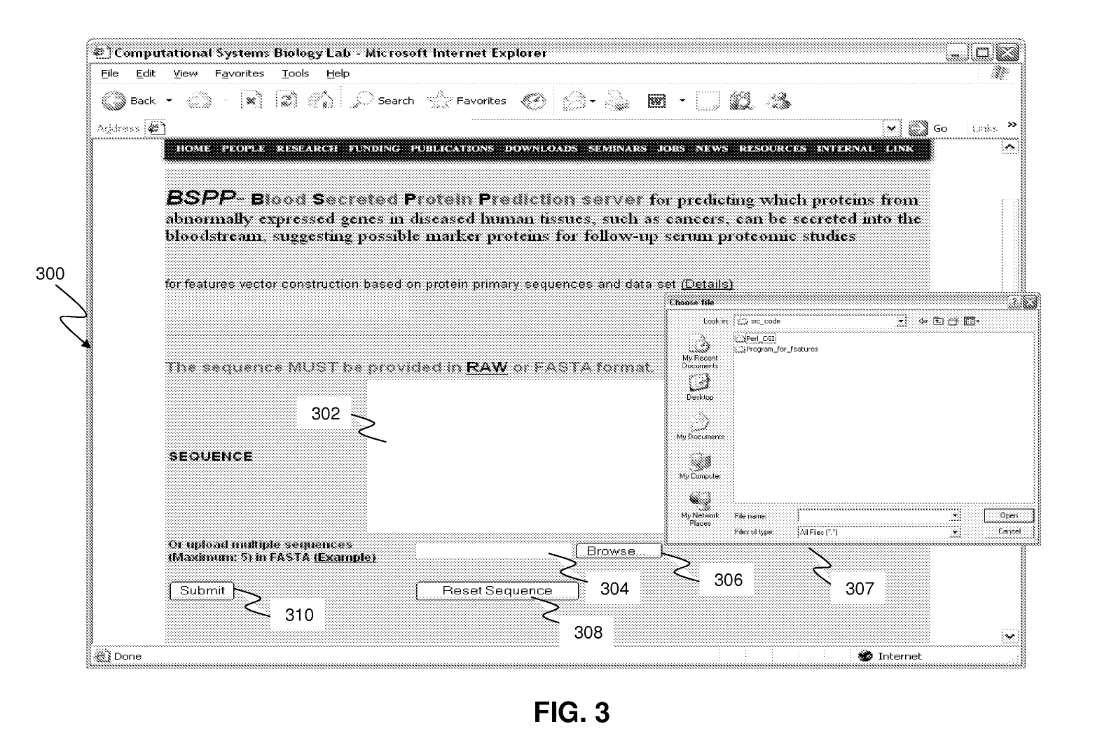

FIGS. 3-6 illustrate a graphical user interface (GUI), according to an embodiment of the present invention. The GUI depicted in FIGS. 3-6 is described with reference to the embodiment of FIG. 1. However, the GUI is not limited to that example embodiment. For example, the GUI may be user interface used to receive protein sequences, as describe in step 119 above with reference to FIGS. 1 and 3. Although in the exemplary embodiments depicted in FIGS. 3-6 GUI 300 is shown as an Internet browser interface, it is understood that GUI 300 can be readily adapted to execute on a display of a mobile device, a computer terminal, a server console, or other display of a computing device. FIGS. 3-6 illustrate GUI 300 is shown as an interface to a Blood Secreted Protein Prediction (BSPP) server. However, in embodiments of the invention, GUI 300 may be used to predict secretion of proteins in other bodily fluids.

Throughout FIGS. 3-6, a similar display is shown with various command regions, which are used to initiate action, input protein sequences, and submit/upload multiple protein sequences for analysis. For brevity, only the differences occurring within the figures, as compared to previous or subsequent ones of the figures, is described below.

FIGS. 3 and 4 illustrate an exemplary GUI 300, wherein pluralities of protein sequences can be inputted by a user into command region 302 in order to predict which proteins can be secreted into the bloodstream, in accordance with an embodiment of the invention. In an embodiment, a system for protein analysis includes GUI 300 and also includes an input device (not shown) which is configured to allow users to select and enter data among respective portions of GUI 300. For example, through moving a pointer or cursor on GUI 300 within and between each of the command regions 302, 304, and 306 displayed in a display, a user can input or submit one or more protein sequences to be analyzed by the system. In an embodiment, the display may be a computer display 730 shown in FIG. 7, and GUI 300 may be display interface 702. According to embodiments of the present invention, the input device can be, but is not limited to, for example, a keyboard, a pointing device, a track ball, a touch pad, a joy stick, a voice activated control system, a touch screen, or other input devices used to provide interaction between a user and GUI 300.

FIG. 3 illustrates how a user can input a protein sequence into command region 302 in the FASTA or raw text formats, in accordance with an embodiment of the invention. This input is one way protein sequences are received in step 119 of method 100 described above with reference to FIG. 1. FIG. 3 also depicts how a user can upload multiple protein sequences using command region 204. In the example embodiment illustrated in FIG. 3, command region 304 can be used to upload up to five protein sequences. However, it is understood that it is within the knowledge of one skilled in the relevant art to readily adapt GUI 300 accept more than five protein sequences. Alternatively, browse button 306 can be used to browse for protein sequences in stored in one or more locations. In an embodiment, browse button 306 can be used to launch window 307 enabling a user to navigate to one or more protein sequence files. By navigating to file storage locations using window 307, a user may upload protein sequences stored in multiple locations, such as memories 708 or 710 of computer system 700 depicted in FIG. 7. Once the desired protein sequences have been entered or uploaded, using command regions 302, 304, and/or window 307, the sequences may be submitted for analysis by selecting submit button 310. In the event a user wishes to clear any input from command regions 302 and/or 304, reset sequence button 308 may be selected.

FIG. 4 depicts a received protein sequence 412 in command region 302. The single protein sequence 412 can be submitted for analysis by selecting submit button 310.

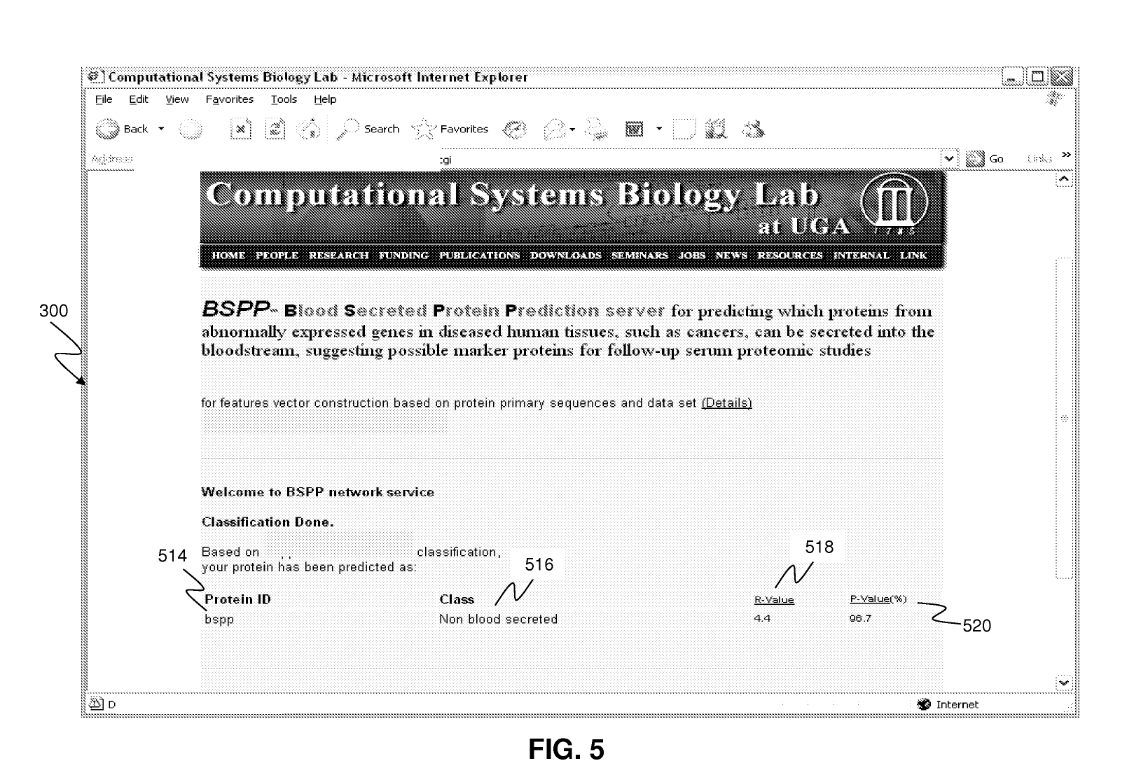

FIG. 5 depicts a negative classification result 516 along with the corresponding protein identifier (ID) 514, R-Value 518, and P-Value 520 for received protein sequence 412. As described above with reference to FIG. 2, there is a statistical relationship between the R-value 518 and P-value 520 which is derived from the analysis of positive and negative samples of proteins, in accordance with an embodiment of the invention. In the example provided in FIG. 5, the protein sequence 412 is not predicted to have been secreted into blood. In an embodiment, the negative classification result 516 is predicted based on a probability calculated in step 121, using a trained classifier, as discussed above with reference to FIG. 1.

FIG. 6 depicts a positive classification result 616 along with the corresponding protein identifier (ID) 514, R-Value 518, and P-Value 520 for received protein sequence 412. As described above with reference to FIGS. 2 and 5, there is a statistical relationship between the R-value 518 and P-value 520 which is derived from the analysis of positive and negative samples of proteins. In the example provided in FIG. 6, a received protein sequence is predicted to be blood-secreted. In an embodiment, the positive classification result 616 is predicted based on a probability calculated in step 121, using a trained classifier, as discussed above with reference to FIG. 1.

### Example Computer System Implementation

Various aspects of the present invention can be implemented by software, firmware, hardware, or a combination thereof. FIG. 7 illustrates an example computer system 700 in which the present invention, or portions thereof, can be implemented as computer-readable code. For example, method 100 illustrated by the flowchart of FIG. 1 and GUI 300 depicted in FIGS. 3-6 can be implemented in computer system 700. Various embodiments of the invention are described in terms of this example computer system 700. After reading this description, it will become apparent to a person skilled in the relevant art how to implement the invention using other computer systems and/or computer architectures.

Computer system 700 includes one or more processors, such as processor 704. Processor 704 can be a special purpose or a general-purpose processor. Processor 704 is connected to a communication infrastructure 706 (for example, a bus, or network).

Computer system 700 also includes a main memory 708, preferably random access memory (RAM), and can also include a secondary memory 710. Secondary memory 710 may include, for example, a hard disk drive 712, a removable storage drive 714, flash memory, a memory stick, and/or any similar non-volatile storage mechanism. Removable storage drive 714 may comprise a floppy disk drive, a magnetic tape drive, an optical disk drive, a flash memory, or the like. The removable storage drive 714 reads from and/or writes to a removable storage unit 718 in a well-known manner. Removable storage unit 718 can comprise a floppy disk, magnetic tape, optical disk, etc. which is read by and written to by removable storage drive 714. It is appreciated that removable storage unit 718 includes a computer usable storage medium having stored therein computer software and/or data.

In alternative implementations, secondary memory 710 can include other similar means for allowing computer programs or other instructions to be loaded into computer system 700. Such means can include, for example, a removable storage unit 722 and an interface 720. Examples of such means can include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 700.

Computer system 700 can also include a communications interface 724. Communications interface 724 allows software and data to be transferred between computer system 700 and external devices. Communications interface 724 can include a modem, a network interface (such as an Ethernet card), a communications port, a PCMCIA slot and card, or the like. Software and data transferred via communications interface 724 are in the form of signals which can be electronic, electromagnetic, optical, or other signals capable of being received by communications interface 724. These signals are provided to communications interface 724 via a communications path 726. Communications path 726 carries signals and can be implemented using wire or cable, fiber optics, a phone line, a cellular phone link, an RF link or other communications channels.

In this document, the terms “computer program medium” and “computer usable medium” are used to generally refer to media such as removable storage unit 718, removable storage unit 722, and a hard disk installed in hard disk drive 712. Signals carried over communications path 726 can also embody the logic described herein. Computer program medium and computer usable medium can also refer to memories, such as main memory 708 and secondary memory 710, which can be memory semiconductors (e.g. DRAMs, etc.). These computer program products are means for providing software to computer system 700.

Computer programs (also called computer control logic) are stored in main memory 708 and/or secondary memory 710. Computer programs can also be received via communications interface 724. Such computer programs, when executed, enable computer system 700 to implement the present invention as discussed herein. In particular, the computer programs, when executed, enable processor 704 to implement the processes of the present invention, such as the steps in method 100 illustrated by the flowchart of FIG. 1 discussed above. Accordingly, such computer programs represent controllers of the computer system 700. Where the invention is implemented using software, the software can be stored in a computer program product and loaded into computer system 700 using removable storage drive 714, interface 720, hard disk drive 712, or communications interface 724.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The following references are hereby incorporated by reference in their entirety:
Adachi, J., Kumar, C., Zhang, Y., Olsen, J. and Mann, M. (2006). The human urinary proteome contains more than 1500 proteins, including a large proportion of membrane proteins. Genome Biology 7(9):R80.
Adkins, J. N., Varnum, S. M., Auberry, K. J., Moore, R. J., Angell, N. H., Smith, R. D., Springer, D. L. and Pounds, J. G. (2002) Toward a human blood serum proteome: analysis by multidimensional separation coupled with mass spectrometry, Mol Cell Proteomics, 1, 947-955.
Altschul, S. F., Madden, T. L., Schaffer, A. A., Zhang, J., Zhang, Z., Miller, W. and Lipman, D. J. (1997) Gapped BLAST and PSI-BLAST: a new generation of protein database search programs, Nucleic Acids Res, 25, 3389-3402.
Anderson, N. L. and Anderson, N. G. (2002) The human plasma proteome: history, character, and diagnostic prospects, Mol Cell Proteomics, 1, 845-867.
Barratt, J. and P. Topham (2007). “Urine proteomics: the present and future of measuring urinary protein components in disease.” CMAJ 177(4): 361-8.
Bateman, A., Birney, E., Cerruti, L., Durbin, R., Etwiller, L., Eddy, S., Griffiths-Jones, S., Howe, K., Marshall, M. and Sonnhammer, E. (2002) The Pfam protein families database., Nucleic acids research, 30, 276-280.
Ben-Hur, A. and Noble, W. S. (2005) Kernel methods for predicting protein-protein interactions, Bioinformatics, 21 Suppl 1, i38-46.
Bendtsen, J. D., Nielsen, H., Widdick, D., Palmer, T. and Brunak, S. (2005) Prediction of twin-arginine signal peptides, BMC Bioinformatics, 6, 167.
Bhasin, M. and Raghava, G. P. (2004) Classification of nuclear receptors based on amino acid composition and dipeptide composition, J Biol Chem, 279, 23262-23266.
Bosques, C. J., Raguram, S, and Sasisekharan, R. (2006) The sweet side of biomarker discovery, Nat Biotechnol, 24, 1100-1101.
Bradford, T. J., Tomlins, S. A., Wang, X. and Chinnaiyan, A. M. (2006) Molecular markers of prostate cancer, Urol Oncol, 24, 538-551.
Brown, J. M. and Giaccia, A. J. (1998) The unique physiology of solid tumors: opportunities (and problems) for cancer therapy, Cancer Res, 58, 1408-1416.
Buckhaults, P., Rago, C., St Croix, B., Romans, K. E., Saha, S., Zhang, L., Vogelstein, B. and Kinzler, K. W. (2001) Secreted and cell surface genes expressed in benign and malignant colorectal tumors, Cancer Res, 61, 6996-7001.
Burbidge, R., Trotter, M., Buxton, B. and Holden, S. (2001) Drug design by machine learning: support vector machines for pharmaceutical data analysis, Comput Chem, 26, 5-14.
Cai, C. Z., Han, L. Y., Ji, Z. L., Chen, X. and Chen, Y. Z. (2003) SVM-Prot: Web-based support vector machine software for functional classification of a protein from its primary sequence, Nucleic Acids Res, 31, 3692-3697.
Castagna, A., Cecconi, D., Sennels L, Rappsilber J, Guerrier L, Fortis F, Boschetti E, Lomas L, Righetti P G. (2005). “Exploring the hidden human urinary proteome via ligand library beads.” J Proteome Res(4): 1917-1930. Chen, Y., Zhang, Y., Yin, Y., Gao, G., Li, S., Jiang, Y., Gu, X. and Luo, J. (2005) SPD—a web-based secreted protein database, Nucleic Acids Res, 33, D169-173.
Cui, J., Han, L. Y., Li, H., Ung, C. Y., Tang, Z. Q., Zheng, C. J., Cao, Z. W. and Chen, Y. Z. (2007) Computer prediction of allergen proteins from sequence-derived protein structural and physicochemical properties, Mol Immunol, 44, 514-520.
Cui, J., Han, L. Y., Lin, H. H, Tang, Z. Q., Ji, Z. L, Cao, Z.; Li, Y. X.; Chen, Y. Z. (2007) Advances in Exploration of Machine Learning Methods for Predicting Functional Class and Interaction Profiles of Proteins and Peptides Irrespective of Sequence Homology Current Bioinformatics, 2, 95-112(118).
Dennis, G., Sherman, B. T., Hosack, D. A., Yang, J., Gao, W., Lane, H. C., and Lempicki, R. A. (2003). “DAVID: Database for Annotation, Visualization, and Integrated Discovery.” Genome Biology 4: P3.
Doudna, J. A. and Batey, R. T. (2004) Structural insights into the signal recognition particle, Annu Rev Biochem, 73, 539-557.
Dubchak, I., Muchnik, I., Holbrook, S. R. and Kim, S. H. (1995) Prediction of protein folding class using global description of amino acid sequence, Proc Natl Acad Sci USA, 92, 8700-8704.
Eisenhaber, F., Imperiale, F., Argos, P. and Frommel, C. (1996) Prediction of secondary structural content of proteins from their amino acid composition alone. I. New analytic vector decomposition methods, Proteins, 25, 157-168.
Feng, Z. P. and Zhang, C. T. (2000) Prediction of membrane protein types based on the hydrophobic index of amino acids, J Protein Chem, 19, 269-275.
Garrow, A. G., Agnew, A. and Westhead, D. R. (2005) TMB-Hunt: a web server to screen sequence sets for transmembrane beta-barrel proteins. Nucleic Acids Res., 33, W188-92.
Garrow, A. G., Agnew, A. and Westhead, D. R. (2005) TMB-Hunt: An amino acid composition based method to screen proteomes for beta-barrel transmembrane proteins, BMC Bioinformatics, 6, 56.
Graham, S. J. M. a. N. E. (2002) Areas beneath the relative operating characteristics (ROC) and levels (ROL) curves: statistical significance and interpretation, Quart. J. Roy. Meteorol. Soc., 128, 2145-2166.
Guda, C. (2006) pTARGET: a web server for predicting protein subcellular localization, Nucleic Acids Res, 34, W210-213.
Hanahan, D. and Weinberg, R. A. (2000) The hallmarks of cancer, Cell, 100, 57-70.
Horton, P., Park, K. J., Obayashi, T., Fujita, N., Harada, H., Adams-Collier, C. J. and Nakai, K. (2007) WoLF PSORT: protein localization predictor, Nucleic Acids Res, 35, W585-587.
Hua, S, and Sun, Z. (2001) A novel method of protein secondary structure prediction with high segment overlap measure: support vector machine approach, J Mol Biol, 308, 397-407.
Huang, L. J., Chen, S. X., Huang, Y., Luo, W. J., Jiang, H. H., Hu, Q. H., Zhang, P. F. and Yi, H. (2006) Proteomics-based identification of secreted protein dihydrodiol dehydrogenase as a novel serum markers of non-small cell lung cancer, Lung Cancer, 54, 87-94.
Huang, d. a. W., Sherman, B. T. and Lempicki, R. A. (2009). “Systematic and integrative analysis of large gene lists using DAVID Bioinformatics Resources.” Nature Protoc 4: 44-57.
Jardine, N. and Sibson, R. (1968) The construction of hierarchic and non-hierarchic classifications, The Computer Journal, 11, 177-184.
Kim, J. H., Skates, S. J., Uede, T., Wong, K. K., Schorge, J. O., Feltmate, C. M., Berkowitz, R. S., Cramer, D. W. and Mok, S. C. (2002) Osteopontin as a potential diagnostic biomarker for ovarian cancer, JAMA, 287, 1671-1679.
Kim, J. M., Sohn, H. Y., Yoon, S. Y., Oh, J. H., Yang, J. O., Kim, J. H., Song, K. S., Rho, S. M., Yoo, H. S., Kim, Y. S., Kim, J. G. and Kim, N. S. (2005) Identification of gastric cancer-related genes using a cDNA microarray containing novel expressed sequence tags expressed in gastric cancer cells, Clin Cancer Res, 11, 473-482.
Kitano, E. and Kitamura, H. (2002) Synthesis of factor D by gastric cancer-derived cell lines, Int Immunopharmacol, 2, 843-848.
Klee, E. W. and Sosa, C. P. (2007) Computational classification of classically secreted proteins, Drug Discov Today, 12, 234-240.
Lo, K. C., Stein, L. C., Panzarella, J. A., Cowell, J. K. and Hawthorn, L. (2007) Identification of genes involved in squamous cell carcinoma of the lung using synchronized data from DNA copy number and transcript expression profiling analysis, Lung Cancer. 2008 March; 59 (3): 315-31.
Mao, X., Cai, T., Olyarchuk, J. G. and Wei, L. (2005). “Automated Genome Annotation and Pathway Identification Using the KEGG Orthology (KO) As a Controlled Vocabulary.” Bioinformatics 21(19): 3787-3793.
Menne, K. M., Hermjakob, H. and Apweiler, R. (2000) A comparison of signal sequence prediction methods using a test set of signal peptides, Bioinformatics, 16, 741-742.
Mok, S. C., Chao, J., Skates, S., Wong, K., Yiu, G. K., Muto, M. G., Berkowitz, R. S. and Cramer, D. W. (2001) Prostasin, a potential serum marker for ovarian cancer: identification through microarray technology, J Natl Cancer Inst, 93, 1458-1464.
Mott, R., Schultz, J., Bork, P. and Ponting, C. P. (2002) Predicting protein cellular localization using a domain projection method, Genome Res, 12, 1168-1174.
Nair, R. and Rost, B. (2005) Mimicking cellular sorting improves prediction of sub-cellular localization, J Mol Biol, 348, 85-100.
Omenn, G. S., States, D. J., Adamski, M., Blackwell, T. W., Menon, R., Hermjakob, H., Apweiler, R., Haab, B. B., Simpson, R. J., Eddes, J. S., Kapp, E. A., Moritz, R. L., Chan, D. W., Rai, A.J., Admon, A., Aebersold, R., Eng, J., Hancock, W. S., Hefta, S. A., Meyer, H., Paik, Y. K., Yoo, J. S., Ping, P., Pounds, J., Adkins, J., Qian, X., Wang, R., Wasinger, V., Wu, C. Y., Zhao, X., Zeng, R., Archakov, A., Tsugita, A., Beer, I., Pandey, A., Pisano, M., Andrews, P., Tammen, H., Speicher, D. W. and Hanash, S. M. (2005) Overview of the HUPO Plasma Proteome Project: results from the pilot phase with 35 collaborating laboratories and multiple analytical groups, generating a core data set of 3020 proteins and a publicly-available database, Proteomics, 5, 3226-3245.
Osicka, T. M., Panagiotopoulos, S, and Jerums, W (1997). “Fractional clearance of albumin is influenced by its degradation during renal passage.” Clin Sci (Lond) 93(6): 557-64.
Otsuka, M., Matsumoto, T., Morimoto, R., Arioka, S., Omote, H. and Moriyama, Y. (2005) A human transporter protein that mediates the final excretion step for toxic organic cations, Proc Natl Acad Sci USA, 102, 17923-17928.
Pardo, M., Garcia, A., Antrobus, R., Blanco, M. J., Dwek, R. A. and Zitzmann, N. (2007) Biomarker discovery from uveal melanoma secretomes: identification of gp100 and cathepsin D in patient serum, J Proteome Res, 6, 2802-2811.
Pieper, R., Gatlin, C. L. Gatlin, McGrath, A. M. Makusky, A. J., Mondal, M. Seonarain, M., Field, E., Schatz, C. R. Estock, M. A., Ahmed, N. Anderson, N. G and Steiner, S. (2004). “Characterization of the human urinary proteome: a method for high-resolution display of urinary proteins on two-dimensional electrophoresis gels with a yield of nearly 1400 nearly protein spots.” Proteomics(4): 1159-1174.
Pieper, R., Gatlin, C. L., Makusky, A. J., Russo, P. S., Schatz, C. R., Miller, S. S., Su, Q., McGrath, A. M., Estock, M. A., Parmar, P. P., Zhao, M., Huang, S. T., Zhou, J., Wang, F., Esquer-Blasco, R., Anderson, N. L., Taylor, J. and Steiner, S. (2003) The human serum proteome: display of nearly 3700 chromatographically separated protein spots on two-dimensional electrophoresis gels and identification of 325 distinct proteins, Proteomics, 3, 1345-1364.
Platt, J. C. (1999) Fast Training of Support Vector Machines using Sequential Minimal Optimization. In, Advances in kernel methods: support vector learning. MIT Press Cambridge, Mass., USA, 185-208.
Reczko, M. and Bohr, H. (1994) The DEF data base of sequence based protein fold class predictions, Nucleic Acids Res, 22, 3616-3619.
Rui, Z., Jian-Guo, J., Yuan-Peng, T., Hai, P. and Bing-Gen, R. (2003) Use of serological proteomic methods to find biomarkers associated with breast cancer, Proteomics, 3, 433-439.
Keerthi, S. S., Bhattacharyya, C., Shevade, S. K., and Murthy, K. R. K. (2001) Improvements to Platt's SMO Algorithm for SVM Classifier Design Neural Computation, 13, 637-649.
Schrader, M. and Schulz-Knappe, P. (2001) Peptidomics technologies for human body fluids, Trends Biotechnol, 19, S55-60.
Smialowski, P., Martin-Galiano, A. J., Mikolajka, A., Girschick, T., Holak, T. A. and Frishman, D. (2007) Protein solubility: sequence based prediction and experimental verification, Bioinformatics, 23, 2536-2542.
Sporn, M. B. and Roberts, A. B. (1985) Autocrine growth factors and cancer, Nature, 313, 745-747.
Su, E. C., Chiu, H. S., Lo, A., Hwang, J. K., Sung, T. Y. and Hsu, W. L. (2007) Protein subcellular localization prediction based on compartment-specific features and structure conservation, BMC Bioinformatics, 8, 330.
Tang, Z. Q., Han, L. Y., Lin, H. H., Cui, J., Jia, J., Low, B. C., Li, B. W. and Chen, Y. Z. (2007) Derivation of stable microarray cancer-differentiating signatures using consensus scoring of multiple random sampling and gene-ranking consistency evaluation, Cancer Res, 67, 9996-10003.
Taylor, P. D., Toseland, C. P., Attwood, T. K. and Flower, D. R. (2006) TATPred: a Bayesian method for the identification of twin arginine translocation pathway signal sequences, Bioinformation, 1, 184-187.
Tjalsma, H., Bolhuis, A., Jongbloed, J. D., Bron, S, and van Dijl, J. M. (2000) Signal peptide-dependent protein transport in Bacillus subtilis: a genome-based survey of the secretome, Microbiol Mol Biol Rev, 64, 515-547.
Unwin, R. D., Harnden, P., Pappin, D., Rahman, D., Whelan, P., Craven, R. A., Selby, P. J. and Banks, R. E. (2003) Serological and proteomic evaluation of antibody responses in the identification of tumor antigens in renal cell carcinoma, Proteomics, 3, 45-55.
Wang, L., Li, F., Sun, W., Wu, S., Wang, X. Zhang, L., Zheng, D., Wang J. and Gao Y. (2006). Concanavalin A captured glycoproteins in healthy human urine. Mol Cell Proteomics (5): 560-562.
Welsh, J. B., Sapinoso, L. M., Kern, S. G., Brown, D. A., Liu, T., Bauskin, A. R., Ward, R. L., Hawkins, N. J., Quinn, D. I., Russell, P. J., Sutherland, R. L., Breit, S. N., Moskaluk, C. A., Frierson, H. F., Jr. and Hampton, G. M. (2003) Large-scale delineation of secreted protein biomarkers overexpressed in cancer tissue and serum, Proc Natl Acad Sci USA, 100, 3410-3415.
Welsh, J. B., Zarrinkar, P. P., Sapinoso, L. M., Kern, S. G., Behling, C. A., Monk, B. J., Lockhart, D. J., Burger, R. A. and Hampton, G. M. (2001) Analysis of gene expression profiles in normal and neoplastic ovarian tissue samples identifies candidate molecular markers of epithelial ovarian cancer, Proc Natl Acad Sci USA, 98, 1176-1181.
Wu, J., Mao, X., Cai, T., Luo, J. and Wei L. (2006). “KOBAS server: a web-based platform for automated annotation and pathway identification.” Nucleic Acids Res 34: W720-W724.

What is claimed is:

1. A method for predicting secretion of proteins into a biological fluid, the method comprising:
receiving one or more protein sequences;
identifying features of the received one or more protein sequences; and
determining, using a trained classifier and the identified features, a probability of the received one or more protein sequences being secreted into the biological fluid, wherein the trained classifier accesses a protein feature set comprising properties of collected proteins, and wherein the properties correspond to protein features present in a set of proteins known to be secreted into the biological fluid.

2. The method of claim 1, further comprising, prior to the determining:
constructing a feature set comprising secretory properties of collected proteins, wherein the secretory properties correspond to protein features present in a positive protein set of secreted proteins; and
training a classifier, based on the feature set, to recognize protein features corresponding to proteins that are likely to be secreted into the biological fluid.

3. The method of claim 2, further comprising:
constructing a second feature set comprising properties of proteins known to be secreted into the biological fluid due to one or more pathological conditions;
training the classifier, based on the second feature set, to recognize pathology-associated proteins;
determining, using the trained classifier, if pathology-associated proteins are present in the received one or more protein sequences.

4. The method of claim 3, wherein the one or more pathological conditions include gastric, pancreatic, lung, ovarian, liver, colon, colorectal, breast, nasopharynx, kidney, uterine cervical, brain, bladder, renal, and prostate cancers, melanoma, and squamous cell carcinoma.

5. The method of claim 1, wherein the collected proteins are collected from protein databases.

6. The method of claim 5, wherein the protein databases comprise Swiss-Prot and secreted protein database (SPD) databases.

7. The method of claim 1, wherein the received one or more protein sequences are in a FASTA format.

8. The method of claim 1, wherein the proteins are human proteins.

9. The method of claim 2, further comprising, prior to the constructing:
generating a positive, secreted protein set based upon known secretory proteins for the biological fluid; and
generating a negative, non-secreted protein set based upon known non-secretory proteins for the biological fluid.

10. The method of claim 9, wherein the biological fluid is blood and generating the positive, secreted protein set comprises selecting one or more non-native blood proteins.

11. The method of claim 10, wherein generating the negative, non-secreted protein set comprises selecting non-blood-secretory proteins from a large protein data set that does not overlap with the positive, secreted protein set.

12. The method of claim 11, wherein the large protein data set is a protein family (Pfam) database.

13. The method of claim 2, wherein the secretory properties include:
general sequence features;
physicochemical properties;
structural properties; and
domains and motifs.

14. The method of claim 13, wherein the general sequence features comprise:
amino acid composition;
sequence length;
di-peptides composition;
sequence order;
normalized Moreau-Broto autocorrelation; and
Geary autocorrelation.

15. The method of claim 13, wherein the physicochemical properties comprise:
hydrophobicity;
normalized Van der Waals volume;
polarity;
polarizability;
charge;
secondary structure;
solvent accessibility;
solubility;
unfoldability;
disorder regions;
global charge; and
hydrophobility.

16. The method of claim 13, wherein the structural properties comprise:
secondary structural content; and
shape.

17. The method of claim 13, wherein the domains and motifs comprise:
signal peptide;
transmembrane domains;
glycosylation; and
twin-arginine signal peptides motif (TAT).

18. The method of claim 1, wherein the biological fluid is one or more of saliva, blood, urine, spinal fluid, seminal fluid, vaginal fluid, amniotic fluid, gingival crevicular fluid, or ocular fluid.

19. The method of claim 2, wherein constructing the feature set comprises removing redundant proteins using a Basic Local Alignment Search Tool (BLAST).

20. The method of claim 2, wherein training the classifier comprises training a Support Vector Machine (SVM)-based classifier to predict protein secretion.

21. The method of claim 2, wherein constructing the feature set further comprises updating the feature set by removing one or more features from the feature set based on performance of the trained classifier, thereby producing an updated feature set.

22. The method of claim 2, wherein constructing the feature set further comprises updating the feature set by removing features from the selected features using recursive feature elimination (RFE), thereby producing an updated feature set.

23. The method of claim 21 or 22, wherein training the classifier further comprises training the classifier using the updated feature set.

24. A computer-implemented method for predicting secretion of proteins into a biological fluid, the method comprising:
constructing, by one or more computers, a feature set comprising secretory properties of collected proteins, wherein the secretory properties correspond to protein features present in a positive protein set of secreted proteins;
training a classifier, based on the feature set, to recognize protein features corresponding to proteins that are likely to be secreted into the biological fluid;
receiving one or more protein sequences;
identifying features of the received one or more protein sequences; and
calculating, by one more computers, using the classifier and the identified features, a probability of the received one or more protein sequences being secreted into the biological fluid.

25. A system for predicting secretion of proteins into a biological fluid, the system comprising:
a feature collector configured to construct a feature set comprising secretory properties of collected proteins, wherein the secretory properties correspond to protein features present in a positive protein set of secreted proteins;
a trainer operable to train a classifier, based on the feature set, to recognize protein features corresponding to proteins that are likely to be secreted into the biological fluid;
a receiver configured to receive, via an input device, one or more protein sequences;
a predictor configured to calculate, using the classifier, a probability of the received one or more protein sequences being secreted into the biological fluid; and
an output device configured to display the probability calculated by the predictor.

26. A computer program product comprising a computer useable medium having computer program logic recorded thereon for enabling a processor to predict secretion of proteins into a biological fluid, the computer program logic comprising:
a feature construction module configured to construct a feature set comprising secretory properties of collected proteins, wherein the secretory properties correspond to protein features present in a positive protein set of secreted proteins;
a training module configured to train a classifier, based on the feature set, to recognize protein features corresponding to proteins that are likely to be secreted into the biological fluid;
a receiver configured to receive one or more protein sequences;
a prediction module configured to calculate, using the classifier, a probability of the received one or more protein sequences being secreted into the biological fluid; and
a display module configured to present the probability calculated by the prediction module.

27. A tangible computer-readable medium having stored thereon, computer-executable instructions that, if executed by a computing device, cause the computing device to perform a method for predicting secretion of proteins into a biological fluid, the method comprising:
receiving one or more protein sequences;
identifying features of the received one or more protein sequences; and
determining, using a trained classifier and the identified features, a probability of the received one or more protein sequences being secreted into the biological fluid, wherein the trained classifier accesses a protein feature set comprising properties of collected proteins, and wherein the properties correspond to protein features present in a set of proteins known to be secreted into the biological fluid.

28. The tangible computer-readable medium of claim 27, the method further comprising, prior to the determining:
constructing a feature set comprising secretory properties of collected proteins, wherein the secretory properties correspond to protein features present in a positive protein set of secreted proteins; and
training a classifier, based on the feature set, to recognize protein features corresponding to proteins that are likely to be secreted into the biological fluid.
